(19) United States
(12) Patent Application Publication
(10) Pub. No.: US 2020/0342715 A1
(43) Pub. Date: Oct. 29, 2020

(54) GAMING SYSTEM AND METHOD HAVING SYMBOL COLLECTIONS FOR IMPROVED AWARDS

(71) Applicant: ADP GAUSELMANN GMBH, Espelkamp (DE)

(72) Inventor: Charles Hiten, Lighthouse, FL (US)

(21) Appl. No.: 16/394,955

(22) Filed: Apr. 25, 2019

(51) Int. Cl. G07F 17/32; G07F 17/34

(52) U.S. Cl. CPC G07F 17/3267; G07F 17/34; G07F 17/3213

(57) ABSTRACT

Various implementations of a gaming system and method generate collection symbols and store the collection symbols in collection symbol storage areas. The gaming system issues various awards or triggers various game features based on the generated quantities of collection symbols, such as issuing one or more free games or free rounds of a game, and/or creating additional collection symbols that the gaming system can potentially generate in later plays or rounds of the game. The gaming system issues various awards or triggers various game features based on the accumulated quantities of collection symbols stored in the collection symbol storage areas, such as causing certain symbols in a reel-based slot machine game to become wild for a period of time; issuing different credit awards corresponding to accumulating different predetermined quantities of collection symbols, etc.

### FIELD OF THE DISCLOSURE

The present disclosure relates to gaming devices.

### BACKGROUND

Gaming machines accept wagers from players in exchange for the opportunity to win awards or prizes. Current gaming machines use computing devices that control various technologies to provide specialized systems adapted to gain the attention of players and to keep them engaged with the gaming machines. To retain players' interest, gaming machines that offer new and unconventional functionality are needed.

### SUMMARY

Various implementations of a gaming system and method include generating collection symbols and storing generated collection symbols for awards. In some implementations, the gaming system may issue various awards or trigger various game features based on collected quantities of generated collection symbols. In some implementations, the gaming system may issue one or more free games, free spins, or free additional rounds of a game when at least a predetermined quantity of collection symbols is obtained. In some implementations, when at least a predetermined quantity of collection symbols is obtained, the gaming system may add additional collection symbols that can be generated during future games or future rounds of a game.

The gaming system may further store and accumulate generated collection symbols during one or more plays of a game or rounds of a game in one or more collection symbol storage areas. In some implementations, the gaming system generates the collection symbols in certain symbol display areas. The gaming system may store the generated collection symbols associated with a portion of the symbol display areas in one of the collection symbol storage areas. For example, the gaming system may store collection symbols generated for a column of the symbol display areas in a corresponding one of the collection symbol storage areas associated with that column. For example, the gaming system may display an indication of the stored collection symbols in a region adjacent to the column of symbol display areas in some implementations.

In some implementations, as the gaming system accumulates stored collection symbols, the gaming system may issue various awards or trigger various game features based on the accumulated quantities of collection symbols in the one or more collection symbol storage areas. For example, in some implementations, the gaming system may cause certain symbols in a reel-based slot machine game to become wild for a period of time. As another example, when the gaming system determines that a quantity of stored collection symbols in a collection symbol storage area associated with a column of symbol display areas exceeds a threshold, the gaming system may convert the generated symbols in that column to wild symbols. In some implementations, the gaming system may issue different credit awards corresponding to accumulating different predetermined quantities of collection symbols. For example, the gaming system may issue a first award when a first quantity of symbol storage areas accumulates at least a threshold quantity of the stored collection symbols, and may issue a second, larger award when a second, larger quantity of collection symbol storage areas accumulates at least a threshold quantity of the stored collection symbols. It should be appreciated that the gaming system may issue other suitable awards based on the accumulated quantities of collection symbols.

In some implementations, the gaming system includes symbol display areas associated with video-based slot machine reels (also herein referred to as “reels”). For example, the gaming system may provide a reel matrix with visible symbol display areas. The gaming system may further include symbol sets that provide symbols associated with the reels, and the gaming system may display randomly generated symbols in the symbol display areas from the associated symbol sets. The gaming system may evaluate the displayed symbols in the symbol display areas for winning symbol combinations. The gaming system may provide one or more awards associated with any winning symbol combinations. In some implementations, the reels may also be associated with one or more different symbol sets. In some implementations, the gaming system may include one or more collection symbols sets associated with one or more of the reels. For instance, the gaming system may randomly generate one or more collection symbols from the collection symbol sets and display the generated collection symbols in respective portions of the symbol display areas (e.g., columns) associated with reels. In some implementations, the gaming system may display a generated collection symbol as overlaid over or adjacent to a symbol in one of the symbol display areas. For example, the collection symbol may be sized and positioned so that the gaming system displays both a symbol and the collection symbol in one of the symbol display areas.

In some implementations, the gaming system evaluates the generated symbols in the symbol display areas (excluding any generated collection symbols) for winning symbol combinations. The gaming system may provide one or more awards based on any determined winning symbol combinations. In some implementations, the gaming system may increase or otherwise modify the awards based on the quantity of generated collection symbols during one or more plays of a game or rounds of a game.

The gaming system may also evaluate the symbol display areas for generated collection symbols. In some implementations, the gaming system may move displayed collection symbols to one or more collection symbol storage areas. In some implementations, one or more of the reels are associated with their own collection symbol storage area. In some implementations, if the gaming system determines that a first reel includes a displayed collection symbol, the gaming system may move or create a copy of the collection symbol in a collection symbol storage area associated with the first reel. The collection symbol storage area associated with the first reel can be a portion of a game screen above a portion of the symbol display areas for the first reel. The gaming system may evaluate one or more of the collection symbol storage areas to determine the stored quantities of collection symbols. The gaming system may determine and issue various different awards or trigger various different game features based on the accumulated quantities of collection symbols in the collection symbol storage areas. In some implementations, where the gaming system determines that sufficient quantities of collection symbols have not been accumulated in the collection symbol storage areas, the gaming system enables the player to continue playing the game and attempt to accumulate sufficient collection symbols to win one or more of the various different awards or different game features.

In some implementations, the gaming system provides the ability to collect symbols in a base game. In some base game implementations, the gaming system provides the ability to collect symbols for a predetermined quantity of plays of the game. For example, in some implementations, the ability to accumulate collection symbols is based on a triggering event and may be available for a predetermined quantity of plays of the base game. In some implementations, the ability to accumulate collection symbols during plays of a game is not limited to a predetermined quantity of plays of the base game. In some implementations, the gaming system provides the ability to collect symbols in a bonus game. In some implementations, the gaming system provides the ability to collect symbols during a predetermined quantity of rounds of the bonus game or for as long as the bonus game is active.

In some implementations, the collection symbol is a coin, a token, or a chip. In some implementations, the collection symbol is a stripe or other graphical element, text, image, etc. that the gaming system displays over a symbol generated for a corresponding symbol display area. However, it should be appreciated that any suitable symbol or other graphical element can be used as a collection symbol.

As described above and set forth in greater detail below, gaming systems in accordance with aspects of the present disclosure provide a specialized computing device including non-conventional hardware and software that improve upon the existing technology of human-computer interfaces by providing functionality of generating display outputs that enable players to enjoy different games and generate new awards. Doing so improves the operation of the gaming systems for their specialized purpose by reducing player disappointment with game outcomes and enhancing player excitement for plays of a game.

### BRIEF DESCRIPTION OF THE DRAWINGS

FIG. 1 shows a perspective view illustrating an example of a gaming system in accordance with aspects of the present disclosure.

FIG. 2 shows a functional block diagram illustrating a gaming system in accordance with aspects of the present disclosure.

FIG. 3A-3C show process flow diagrams illustrating an example of a method for operating the gaming system that provides a bonus game for generating and storing collection symbols in accordance with aspects of the present disclosure.

FIGS. 4A and 4B show pictures of gaming system display illustrating examples of a base game in accordance with aspects of the present disclosure.

FIGS. 5A-5E show pictures of a gaming system display illustrating examples of a bonus game for generating and storing collection symbols in accordance with certain aspects of the present disclosure.

FIGS. 6A-6C show pictures of a gaming system display illustrating examples of a bonus game for generating and storing collection symbols in accordance with other aspects of the present disclosure.

FIGS. 7A and 7B show pictures of a gaming system display illustrating examples of a bonus game for generating collection symbols and marking symbol display areas with generated collection symbols in accordance with other aspects of the present disclosure.

### DETAILED DESCRIPTION

Various implementations of gaming systems and methods consistent with the present disclosure include generating collection symbols and storing the collection symbols in one or more collection symbol storage areas. In some implementations, the gaming system may issue various awards or trigger various game features based on the generated quantities of collection symbols, such as issuing one or more free games, free spins, or free additional rounds of a game, and/or creating additional collection symbols that the gaming system can potentially generate in later plays or rounds of the game. In some implementations, the gaming system may issue various awards or trigger various game features based on the accumulated quantities of collection symbols stored in the collection symbol storage areas, such as causing certain symbols in a reel-based slot machine game to become wild for a determined period of time; issuing different credit awards corresponding to accumulating different predetermined quantities of collection symbols; etc. In some implementations, the generation and storage of the collection symbols may be triggered by a base game, such as a gaming system generating and displaying a predetermined triggering symbol or symbol combination in a reel-based slot machine game.

In some implementations, a gaming system includes a cabinet, a processor, a display device supported by the cabinet, an input device supported by the cabinet, a value acceptor supported by the cabinet, a value dispenser supported by the cabinet, and a memory device that stores program instructions. The program instructions, when executed by the processor, control the gaming device to perform operations including establishing a credit balance based at least in part on a monetary value received by the value acceptor. The operations can also include placing a wager following receipt of a wager input via the input device, the credit balance being decreased by the wager. The operations can also include generating and storing collection symbols in one or more collection symbol storage areas. The operations can also include accumulating stored collection symbols, and issuing various awards or triggering various game features based on the accumulated quantities of collection symbols. The operations can further include displaying, on the display device, an award based on any winning symbol combinations and/or the accumulated quantities of collection symbols, the credit balance being increased by the award, and issuing value from a value dispenser based on the credit balance upon receipt of a cash out signal via the input device.

### Gaming Device Platform

The features and advantages of the gaming system and method described herein may be provided to a player via a gaming device platform that includes various structures and components for allowing player interaction with the gaming device. While only one gaming device platform will be described in detail herein, it is understood that the features, objects, and advantages of the gaming system described herein may be implemented in one or more alternative gaming device platforms.

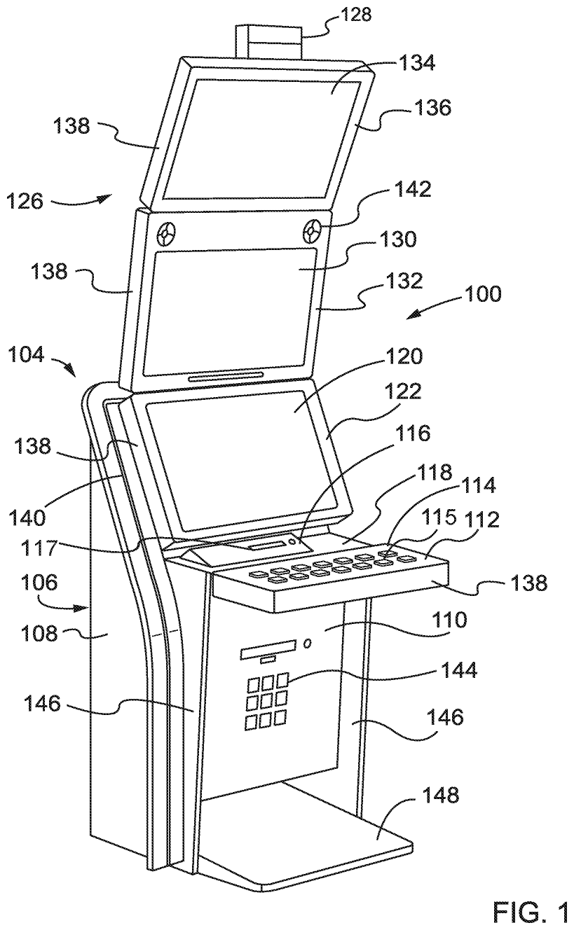

FIG. 1 shows a perspective view illustrating an example of gaming system 100 in accordance with aspects of the present disclosure. Such gaming system 100 may be referred to as a slot machine and, as illustrated, is housed in a cabinet 104 (e.g., a housing) constructed so that a player can operate and play the gaming system 100 while standing or sitting. The cabinet 104 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 104, 106, 108, 110 (as well as the base panel and the top panel surface) may be interconnected along their edges and cooperate to form the cabinet 104, which encloses and houses components of the gaming system 100, as can be seen in FIG. 1. The cabinet 104 may function to securely protect local control system, technology components, and provide support for game display(s) and player input and output interactions with the gaming system 100, such as describe herein below.

While the example cabinet 104 is depicted as having a particular shape, structure, and organization, it should be appreciated that a wide variety of cabinet enclosure sizes, shapes, and designs are possible for the gaming system 100. For example, the cabinet panels 104, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 104 includes input and output areas generally designated as the player interaction area 112. The player interaction area 112 may be located on the front top side of cabinet 104 and, as shown, on a panel structure that extends outwardly from the gaming system 100 in a player's direction. The player interaction area 112 may contain player input and output structures, including a player control area 114, a player value acceptor and dispenser area 116, and player convenience input area 118.

The player control area 114 includes one or more input devices 115, such as buttons or touch sensitive areas, through with which players may interact with the gaming system 100 so as to direct game play. It is expected that the cabinet 104 provides an easily accessible location and support for player input/output (I/O) interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/player tracking cards may be associated with a player account and are utilized by the card-issuing entity to monitor or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enables a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of input locations on the cabinet 104 may be dependent upon the game buttons, the type of value wagered, and the player conveniences utilized in the deployment configuration of gaming system 100.

With continuing reference to FIG. 1, in some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in round, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display 120 may span the one or more portions of the cabinet 104 (e.g., lower body cabinet portion 106 and upper body cabinet body portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game displays.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical reels with reel strips containing game indicia and step motor controllers may be employed to provide game information to a player. In some implementations, the reel strips may include printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the base game display(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming device displays frames, as well as the player interaction area, to highlight these areas.

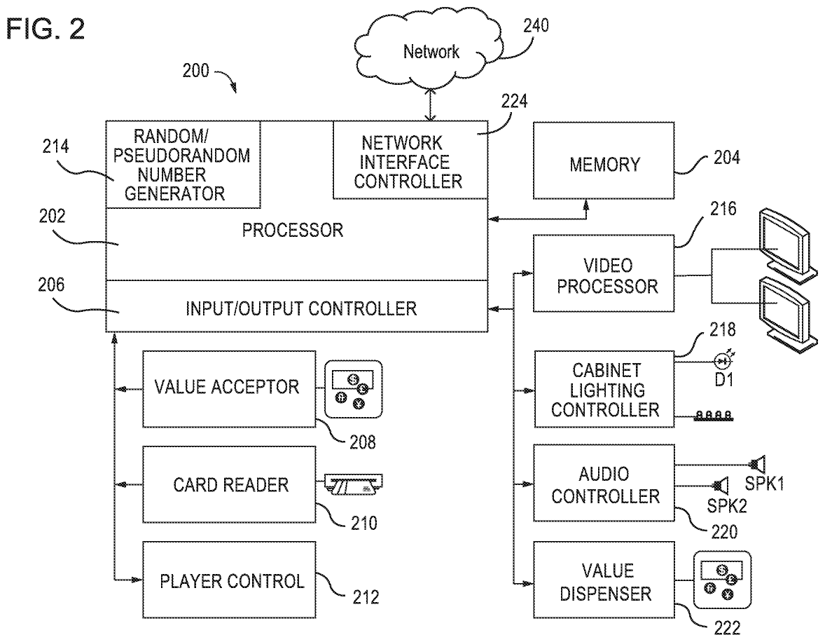

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 104 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 104 includes cabinet accent lighting 140. In some implementations, cabinet accent lighting 140 is LED rope lighting mounted flush with the front side edge of the cabinet side panels 108. The LED rope lighting can generate any of suitable colors and are controlled by cabinet lighting controller and a processor of gaming system 100 to selectively mix the emitted light colors in a manner to create any color in the same manner as the frame edge lighting.

In various implementations, gaming system 100 includes one or more audio speakers 142 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 142 are shown mounted on the upper corners of second display frame 132. Any suitable number of additional speakers 142 may be provided on additional display frames or on the lower cabinet body portion 106 as desired.

The speakers 142 designed for emitting bass vibrations may be included in some implementations. Placement of the speakers 142 may be selected to enhance the sound emitting characteristics of the gaming system 100. For example, bass speakers or additional speakers 144 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing the gaming system 100 in a seated position. Foot rest 148, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary, and/or 3) provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 104 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 illustrates a functional block diagram of a control unit 200 of a gaming system (e.g., gaming system 100) configured to perform specialized game functions and operations, consistent with the implementations described herein. The functional elements shown in FIG. 2 cooperate, on a broad and general level, to function as a gaming system. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In accordance with aspects of the present disclosure, the control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one implementation, the control unit 200 is also configured to communicate with a server device through a network.

In some implementations, the control unit 200 includes at least one processor 202 (e.g., a central processing unit (CPU)). In some implementations, the processor 202 is specially configured with arithmetic logic units and math co-processors, also known as floating point units, for performing the gaming consistent with the various implementations disclosed herein. In some implementations, the specially configured processor 202 includes registers for holding instructions or other data, and cache memory for storing data for faster operation thereupon. In some implementations, the specially configured processor 202 may be a multi-core processor that includes two or more processors for enhanced performance, more efficient parallel processing, or other advantageous computing functions. In another implementation, the specially configured processor 202 may be one or more processing devices such as microprocessor(s) or integrated circuit(s) and may include one or more controllers. It should be appreciated that in some implementations, a general-purpose processor could be programmed to perform the functions of the specially configured processor 202.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

At least one specially configured processor 202 or controller of control unit 200 may be specially configured to communicate with at least one memory device 204, generally shown as memory device 204 in FIG. 2. In some implementations, the memory device 204 includes one or more memory structures for storing instructions and various types of game data. The memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in some implementations, communication with the memory device 204 by the specially configured processor 202 or a controller, encompasses the processor or controller accessing the memory device 204, exchanging data with the memory device 204, or storing data to the memory device 204.

The memory device 204 may store all program code and game code (collectively the “code”), and operation data necessary for the operation of the control unit 200 providing a gaming device and execution of the gaming features described hereinbelow. In an alternative implementation, game code and operation data necessary for the operation of the control unit 200 may be stored in a distributed manner such that some code is stored in memory device 204 and other code is stored remotely from the control unit 200. In some implementations, the code and operation data necessary for the operation of the control unit 200 includes, for example, basic input and output function data, instruction fetching data, bus and network communication protocol data, and like data necessary for an operational gaming device. In some implementations, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in removable game cartridges or flash drives, a compact disk ROM, a digital versatile disk (DVD) optical storage technology, or suitable other fixed non-transitory storage mediums. In another implementation, part or all of the code and operational data for operation of the gaming device or for execution of the game features may be stored in a remote memory structure and be downloaded to the memory device 204 via a network connection.

In some implementations, the control unit 200 may utilize any combination of memory devices such as random access memory devices (RAMs), unalterable memory devices (ROMs), and mass storage devices for securely storing and securely communicating the software components or code that facilitate game play and other functions of the control unit 200. The memory devices may store software components or codes that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the control unit 200.

In some implementations, memory devices, such as memory device 204, with the software components and other data may be secured and authenticated by authentication software stored in an unalterable memory device within the housing of the control unit 200. The control unit 200 may also include application specific integrated circuits (ASICs) to perform the security and authentication functions. At any appropriate time, such as before each play of a game, at a predetermined interval, upon transfer of any game data or any software components from a mass storage to the memory device 204, or upon demand, the control unit 200 (using a processor such as processor 202 or a separate ASIC) may execute an authentication routine and perform an authentication of any software component or other data of the control unit 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the control unit 200 may allow game play to proceed. However, when the message digests do not match, the control unit 200 may determine that the software component under authentication may be corrupted or fraudulent and game play may be halted. It should be appreciated that the control unit 200 may perform other suitable security and authentication checks on the game data or software components. Such authentication and security devices and functions are unique to gaming and casino industry to minimize or prevent fraud in gaming devices and gaming systems.

For a player to interact with a gaming device, the control unit 200 receives and processes player inputs, and the control unit 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for the attached input devices and output devices. In this manner, specially configured processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 208 for game play. Alternatively, a player deposits value into a gaming device by inserting an encoded paper ticket into a value acceptor 208 for game play in some implementations. The value acceptor 208 can be combined with a currency reader and validator, and a code reader for reading value encoded on paper tickets. The value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming system 100. During game play, the specially configured processor 202 processes a player's wagers and determines the amount of credits to debit from the player's credit balance. When a winning outcome is obtained, the specially configured processor 202 is configured to determine the amount of credits to add to the player's credit balance.

As previously mentioned with respect to FIG. 1, a variety of value acceptance arrangements are possible. In some implementations, the value acceptor 208 could include magnetic strip or chip card readers to accept and transfer value. The value acceptor 208 may also be configured to accept and transfer non-traditional currencies such as digital currencies. In these implementations, I/O controller 206, a specially configured processor 202, or both contain appropriate control instructions to communicate and extract value from the inserted item containing value. In some implementations, use of a magnetic strip or embedded chip card, for example a bank card, for value insertion requires the specially configured processor 202 to communicate, via network interface controller 224 (described below), with devices external to a gaming device.

In some implementations, a card reader 210 may be included in gaming system 100 to accept player loyalty cards. For example, card reader 210 can extract account identifying information from the card and utilizes this information to access the associated account information stored remotely via network interface controller 224. In implementations where player loyalty/player tracking systems are employed, a player's loyalty account and record of gaming activity can be stored in a networked storage location or database. The specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various implementations, a player control 212 receives a player's game inputs and communicates the player's game inputs to the specially configured processor 202. The player's game inputs may include, but are not limited to, wager amounts, pay line selections, game control signals, and cash-out signals. The player control 212 may generate signals based on button presses, touch screen activations, or voice control. The player-initiated signals are propagated to the specially configured processor 202 by the I/O controller 206. Further, the player-initiated signals may direct and inform execution of the game instructions stored in the memory device 204 and configured to be executed by the specially configured processor 202.

In some implementations, the specially configured processor 202 is configured to execute stored program code and instructions which generate random numbers or pseudo-random numbers. In some implementations, as illustrated in FIG. 2, a random number generator (RNG) 214 is a software module configured to be executed by the specially configured processor 202 for the generation of a true random or pseudo-random number. The code for RNG 214 may be stored in the memory device 204. The RNG 214 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 214, patterns of symbols are compared to determine wagering outcomes. In an alternative implementation, gaming system 100 may include a hardware based random number generator that is in communication with specially configured processor 202 to supply random numbers for game generation purposes. The hardware based random number generator may be incorporated into specially configured processor 202 or can be separate from specially configured processor 202.

In yet another implementation, the random generation of “numbers” or symbols may be performed with electro-mechanical components. For example, gaming devices such as gaming system 100 may incorporate mechanical reels rotatable about a common axis. Indicia or symbols may be positioned around the periphery of the reels. The indicia or symbols on the reels may indicate separate detectable reel stop positions. The reels can be set into a spinning/rotation motion by pulling a lever or pushing a button. In some implementations, the gaming system 100 can stop the reels by a gaming device actuating, on a random timing basis, a suitable mechanical or electro-mechanical reel brake. When the reels stop rotating, one or more displayed stop positions of the reels are detected. Since the stop positions are associated with respective indicia or symbols, the gaming device can determine whether the combination of stop positions (i.e., translating to a combination of displayed symbols) results in a winning symbol combination.

Returning to FIG. 2, the control unit 200 controls the function and output of an output devices utilized by a gaming device. In various implementations, I/O controller 206 serves as an interface unit between specially configured processor 202 and output devices such as video processor 216, cabinet lighting controller 218, audio controller 220, and value dispenser 222.

In some implementations, the video processor 216 communicates with specially configured processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video reels containing sets of gaming symbols.

It should be appreciated that in certain other implementations where physical mechanical reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with specially configured processor 202. In certain implementations which utilize sound design, specially configured processor 202 may utilize audio controller 220 to coordinate and control the sound emissions. In some implementations, audio controller 220 may include one or more audio processing cards for generating sound and for driving the one, two or more speakers that may be included with a gaming device.

In various implementations, players may collect remaining credit value by initiating a signal via player control 212 which is communicated to specially configured processor 202 via I/O controller 206. The signal triggers a readout of the player's credit amount and specially configured processor 202 initiates a value dispensing signal which, in round, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the specially configured processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the control unit 200 may communicate with one or more devices outside the gaming device. For example, gaming system 100 may be connected to a larger network 240 via a local area network (LAN) or a wide area network (WAN). The control unit 200 may communicate with one or more central servers, controllers, or remote devices to execute games, establish credit balances, participate in jackpots, etc. In such implementations, network communications and connections are accomplished via a network interface controller 224. Network interface controller 224 can be a digital circuit board or card installed in control unit 200 to provide network communications with external devices.

In some implementations, various additional features and functions are performed by the control unit 200. For example, the control unit 200 may be specially configured with appropriate software to track all game play events that occur on a gaming device. In some implementations, the control unit 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

### Gaming System Operation

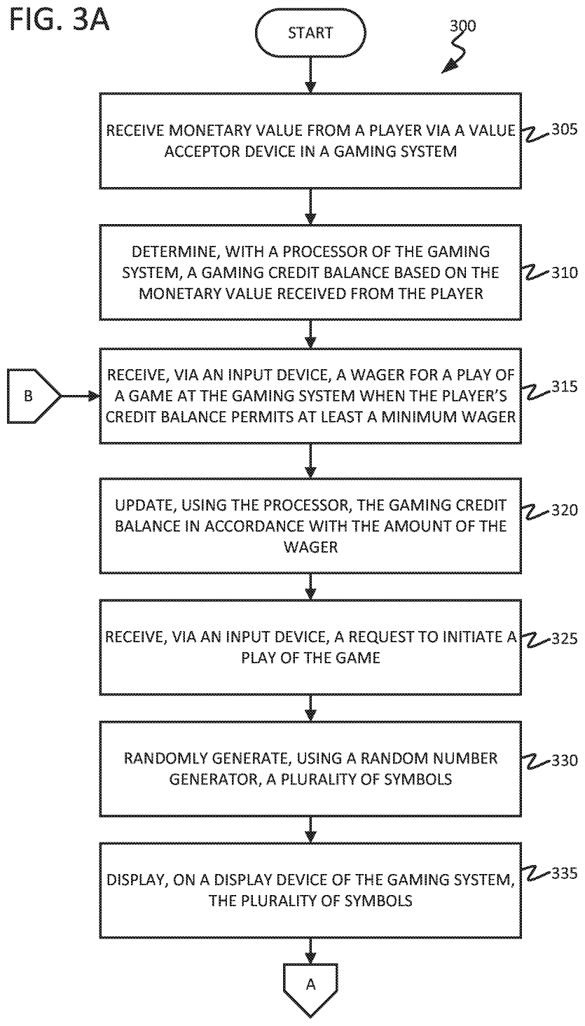

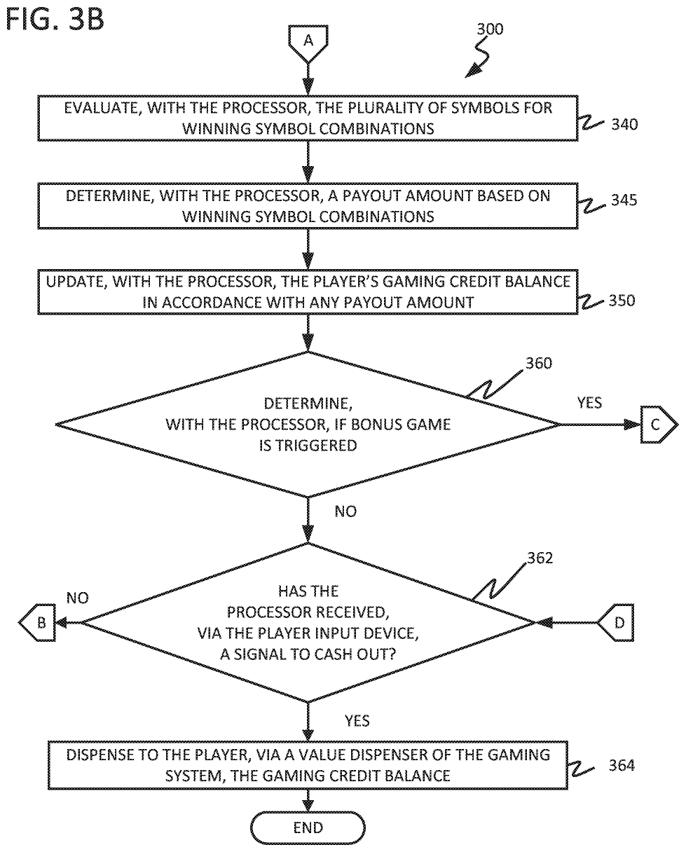

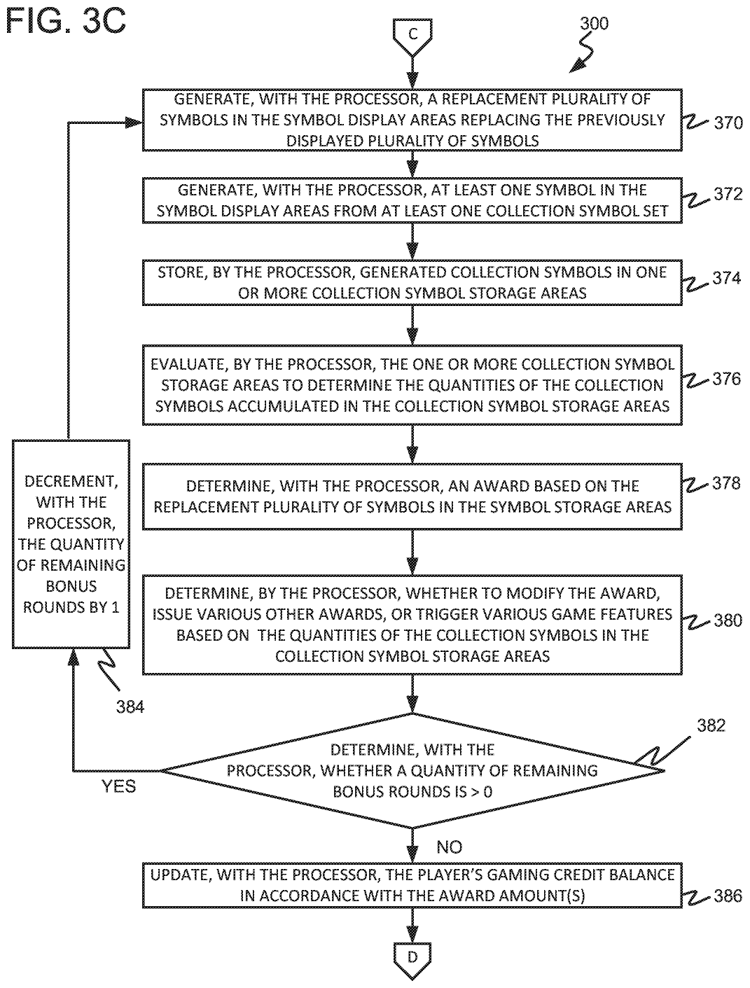

The flowcharts in FIGS. 3A-3C illustrate functionality and operation of possible implementations of systems, devices, methods, and computer program products according to various implementations of the present disclosure. Each block in the flow diagrams of FIGS. 3A-3C can represent a module, segment, or portion of program instructions, which includes one or more computer executable instructions for implementing the illustrated functions and operations. In some alternative implementations, the functions and/or operations illustrated in a particular block of the flow diagram can occur out of the order shown in FIGS. 3A-3C. For example, two blocks shown in succession can be executed substantially concurrently, or the blocks can sometimes be executed in the reverse order, depending upon the functionality involved. It will also be noted that each block of the flow diagram and combinations of blocks in the block diagram can be implemented by special purpose hardware-based systems that perform the specified functions or acts, or combinations of special purpose hardware and computer instructions. In some implementations, the flowcharts can include more blocks or fewer blocks.

FIGS. 3A-3C show a process flowchart illustrating an example of operation 300 of operating the gaming system (e.g., gaming system 100) that generates and stores collection symbols in accordance with aspects of the present disclosure. FIGS. 3A-3C describe parts of a base or primary game and a bonus game for generating and storing collection symbols. However, it should be understood that the gaming system may generate and store collection symbols in a base or primary game. Furthermore, the gaming system may generate and store collection symbols as a bonus game, such as selectively triggering the generation and storage of the collection symbols or other bonus game features based on symbols displayed during a base game.

In some implementations, one or more processors (e.g., processor 202) of the gaming system are configured, via instructions stored in a memory device (e.g., memory 204 or a storage system), to perform the operation 300. In block 305, the gaming system receives monetary value via a value acceptor device (e.g., value acceptor 208). In block 310, the gaming system determines a credit balance based on the monetary value received from the player in block 305 at the value acceptor device. In block 315, the gaming system receives a wager for a play of a game from a player via an input device (e.g., player controller 212) using, e.g., the credit balance determined at block 310.

In some implementations, the gaming system allows the player to place a minimum wager, a maximum wager, or any suitable wager amount. In some implementations, the player's wager amount may determine the value of some of the available awards. Depending on the wager amount, the gaming system may also enable the player to select pay lines across displayed symbol positions (e.g., symbol display areas) on reels in a game in which to place wagers. Although in some implementations, the gaming system selects the wagered pay lines automatically based on the player's wager. Wagered pay lines may be referred to herein as active pay lines. In some implementations, the gaming system uses ways pays to determine awards. In some implementations, the ways-pays may be used as an alternative to or in addition to pay lines. In some implementations, the gaming system determines whether the credit balance determined at block 315 includes enough credits to enable the player's selected wager. The gaming system may prevent the player from placing the wager and starting a play of a game if the player's credit balance is not sufficient to support the player's selected wager. If enough credits are not available in the player's credit balance, the gaming system enables the player to insert additional value to obtain the minimum credit level or to cash out of the gaming system. At block 320, the gaming system updates the credit balance determined at 310 in accordance with the amount wagered at 315.

At block 325, the gaming device receives a request to initiate a play of a base game via the input device. For example, where the gaming system includes a slot machine for a base game, the player may press a spin button on the gaming system to start spinning slot machine reels of the gaming system for a play of the game. In some implementations, a play of a game begins with a wager and activation of a game and the play of the game ends when the base game, the bonus game, or both have completed (depending on whether the bonus game is played). In another implementation, one play of a game comprises the processor executing blocks 315-386 and terminating at either block 360 or 362 depending on whether the gaming system activates the bonus game. In some implementations, block 362 and block 364 are not part of a play of a game. In alternative implementations, block 362 and block 364 are part of a play of a game.

It should be appreciated that reels or slot machine reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

At block 330, the gaming system randomly generates, using a random number generator (e.g., random number generator 214), a plurality of symbols. The gaming system may generate the plurality of symbols from one or more symbol sets for the base game. The plurality of symbol sets may include the same or different symbols. The symbol sets may include the same or different quantities of symbols. The quantities of symbols used in the symbol sets may be determined in accordance with a desired statistical outcome for generating symbols. The symbols used in the plurality of symbol sets can be any suitable symbol. In some implementations, the symbol sets may include numbers, letters, geometric figures, symbols, images, characters, blank symbols (e.g., the absence of symbols), animations, transparent symbols (e.g., symbols that permits underlying symbols to be visible), or any other suitable graphical depiction. The symbols in the set of symbols may include pay symbols and special or designated symbols.

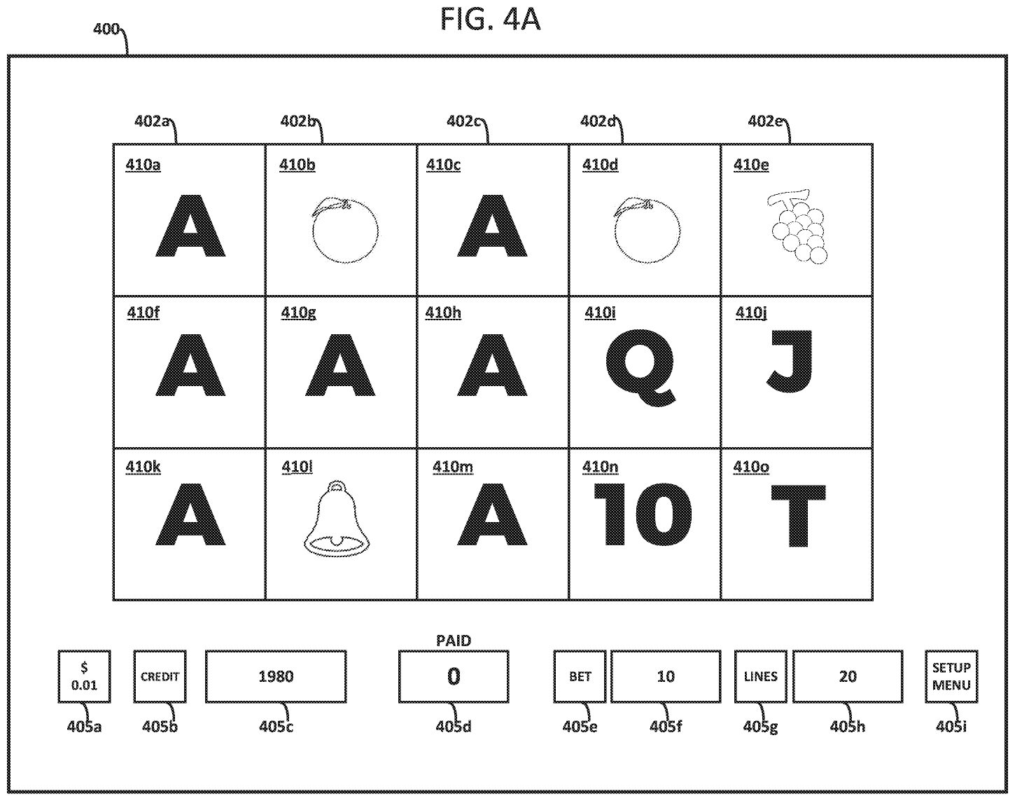

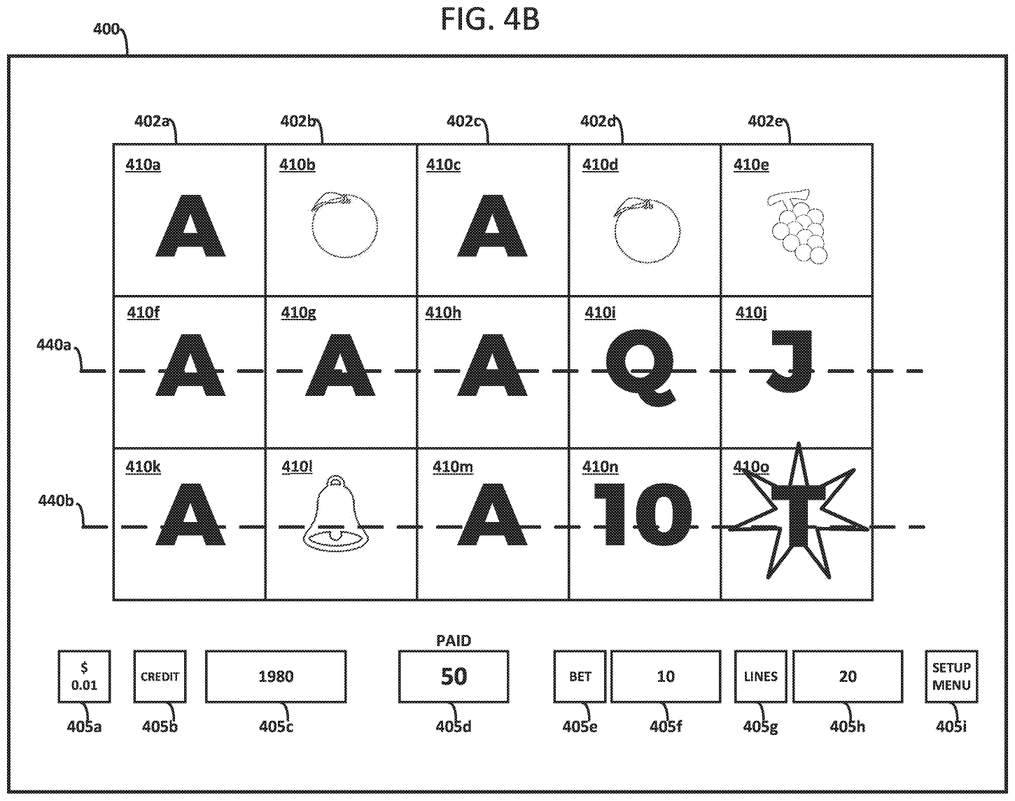

In some implementations, the gaming system may generate the plurality of symbols for display on one or more reels (e.g., reel 402a in FIG. 4A). In some implementations, the gaming system may generate the symbols for display on a set of reels (e.g., reels 402a -402e in FIG. 4A). In some such implementations, the reels are associated with respective sets of symbols. However, as noted above, in some implementations, the gaming system does not use reels and the plurality of symbols can be displayed for different configurations. At block 335, the gaming system causes a display device (e.g., first display device 120) to display the symbols generated at 330. For example, in a game using reels, the gaming system may display the generated symbols in visible symbol display areas of the individual reels (e.g., visible stop positions of a mechanical reel).

Turning now to FIG. 3B, as indicated by off-page connector A, at block 340, the gaming system evaluates the displayed symbols for winning symbol combinations. In some implementations, the gaming system evaluates the displayed symbols across active or wagered pay lines for winning symbol combinations. In some implementations, the gaming system may evaluate the display symbols based on ways pays without using active pay lines. In some implementations, the gaming system evaluates the winning symbol combinations based on various pay lines. The gaming system may evaluate the player selected pay lines, gaming system assigned pay lines, or pay lines assigned as active in some other manner for the play of the game. In some implementations using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In some implementations, a pay table may indicate that as few as one symbol may be associated with a payout. Alternatively, two or more symbols may be used to form winning symbol combinations that result in a payout.

At block 345, the gaming system determines a payout amount based on the winning symbol combinations evaluated at block 340. At block 350, the gaming system updates the player's gaming credit balance in accordance with the payout amount determined at 345. As noted above, the blocks illustrated in FIGS. 3A-3C can be rearranged in any suitable order. As such, it should be appreciated that the gaming system may update the player's gaming credit balance at other suitable times.

In some implementations, as indicated in block 360, the gaming system determines whether a bonus game is triggered. In some implementations, the gaming system evaluates the displayed symbols for at least one triggering symbol or for at least one triggering symbol combination of predetermined symbols that triggers the bonus game. It should also be appreciated that in some implementations, events other than generating one or more of a predetermined symbol or other symbol combinations may trigger the bonus game. For example, the gaming system may include or be in communication with a bonus controller, and the bonus controller may randomly determine, or determine based on a predetermined triggering event (e.g., a quantity of games played) to trigger or activate the bonus game.

Where the gaming system determines that the bonus game for generating and storing collection symbols is triggered, the gaming system may execute the bonus game beginning at block 370, as indicated by off-page connector C. Alternatively, when the gaming system determines that the bonus game (or other bonus game) is not triggered, in block 360, operation 300 moves to block 362. In some implementations, as indicated in block 362, the gaming system may receive a signal to end game play or “cash out” via an input device of the gaming system (e.g., which would end the gaming session). In such a situation, the gaming system dispenses a value to the player, through a value dispenser, based on the player's gaming credit balance as illustrated in block 364 and operation 300 ends.

If the gaming system processor has not received a signal to end game play (e.g., the player continues a gaming session to play another play of the game) via the player input device, the process of operation 300 returns to block 315, as indicated by off-page connector B. The gaming system may receive, via a player input device, a wager for another play of the game and continue operation 300 from block 315. However, in some implementations, the wager may not be accepted if the player has fewer credits than the player's selected wager amount, as shown in block 315.

Turning now to FIG. 3C, as indicated by off-page connector C, the gaming system enters a bonus game as part of the play of the game. In some implementations, the gaming system may provide the player with a predetermined quantity of bonus rounds as part of the play of the game. It should be appreciated that a bonus round can be free spins or free games in certain implementations. For example, the gaming system may provide the player with five bonus rounds that can be executed before ending the play of the game. In some implementations, the gaming system generates, for a round of the bonus game, at block 370, a plurality of replacement symbols in the symbol display areas, similar to the generation of symbols at block 330. For example, the gaming system, at block 370, may use a random number generator (e.g., random number generator 214) to randomly generate symbols for one or more reels of the gaming system from one or more symbol sets. In some implementations, the symbol sets can be the same or different from the symbol sets used for the base game. At block 370, the gaming system may further cause a display device (e.g., first display device 120) to display the generated plurality of replacement symbols in symbol display areas.

In some implementations, the gaming system at block 370 includes symbol display areas associated with video-based slot machine reels (also herein referred to as “reels”). For example, the gaming system may provide a reel matrix with visible symbol display areas. The reels can be the same or different from the reels used in the base game. The gaming system may further include different symbol sets that provide symbols associated with the reels, and the gaming system may display randomly generated symbols in the symbol display areas from the associated symbol sets. In some implementations, the reels may be associated with one or more different symbol sets.

Continuing with FIG. 3C, the gaming system generates, with a processor, one or more collection symbols in the symbol display area in block 372. At block 372, the gaming system may use a random number generator (e.g., random number generator 214) to randomly generate collection symbols for one or more of the reels of the gaming system from one or more collection symbol sets. A collection symbol set may include a plurality of symbols. The plurality of symbols may include one or more collection symbols. The plurality of symbols may include symbols other than collection symbols, such as blank symbols or other suitable symbols discussed above. In a reel-based bonus game or a bonus game with columns of symbol display areas, the gaming system may include a reel or a column of symbol display areas that is associated with a particular collection symbol set. In some implementations, one or more reels or columns of symbol display areas in a bonus game may be associated with a particular collection symbol set. Where a plurality of collection symbol sets are used, the different collection symbol sets may include the same or different quantities of collection symbols. The gaming system may further cause a display device (e.g., first display device 120) to display generated collection symbols in the symbol display areas associated with the generated replacement symbols of block 370. In some implementations, the collection symbol is a coin, a token, or a chip. In some implementations, the collection symbol is a stripe or some other suitable graphical element, text, image, etc. that the gaming system displays with or over a symbol generated for a corresponding symbol display area. However, it should be appreciated that any suitable symbol or other graphical element can be used as a collection symbol.

When the generated replacement symbols of block 370 are associated with a slot-reel game, the gaming system at block 372 may include one or more collection symbols sets associated with the reels. For instance, the gaming system may randomly generate one or more collection symbols from the collection symbol sets and display the generated collection symbols in respective portions of the symbol display areas (e.g., columns) associated with reels. In some implementations, a generated collection symbol is overlaid over or adjacent to a symbol in one of the symbol display areas. For example, the collection symbol may be sized and positioned so that the gaming system displays both a symbol and the collection symbol in one of the symbol display areas.

At block 374, the gaming system may further store and accumulate generated collection symbols in one or more collection symbol storage areas. In some implementations, the gaming system generates the collection symbols in certain symbol display areas in block 370. The gaming system may store the generated collection symbols associated with a portion of the symbol display areas in one of the collection symbol storage areas in block 374. For example, the gaming system at block 374 may store collection symbols generated for a column of the symbol display areas in a corresponding one of the collection symbol storage areas associated with that column. For example, the gaming system at block 374 may display an indication of the stored collection symbols in a region adjacent to the column of symbol display areas. In some implementations, the gaming system may move collection symbols displayed in the symbol display areas to one or more collection symbol storage areas. In some implementations, one or more of the reels are associated with their own collection symbol storage area. In some implementations, if the gaming system determines that a first reel includes a displayed collection symbol, the gaming system may move or create a copy of the collection symbol into a collection symbol storage area associated with the first reel, such as a portion of a display above a portion of the symbol display areas for the first reel.

At block 376, the gaming system may evaluate the one or more collection symbol storage areas to determine the quantities of the collection symbols accumulated and stored in the collection symbol storage areas. For example, the gaming system may determine a quantity of collection symbols accumulated in one or more of the collection symbol storage areas.

At block 378, the gaming system evaluates the generated symbols in the symbol display areas (e.g., excluding any generated collection symbols) for winning symbol combinations. In some implementations, the gaming system evaluates the displayed plurality of replacement symbols for winning symbol combinations. The gaming system may evaluate the player selected pay lines, gaming system assigned pay lines, or pay lines assigned as active, or in some other manner for the play of the bonus round. In some implementations using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In some implementations, a pay table may indicate that as few as one symbol may be associated with a payout. Alternatively, two or more symbols may be used to form winning symbol combinations that result in a payout.

At block 380, in some implementations, the gaming system may determine whether to modify the award, issue various other awards, and/or trigger various game features based on the quantity of generated collection symbols and/or the accumulated quantities of the collection symbols in the collection symbol storage areas. For example, the gaming system may evaluate the collection symbol storage areas, and the gaming system may increase or otherwise modify the award determined in block 378 based on the quantity of stored collection symbols.

At block 380, in some implementations, the gaming system may issue one or more free additional bonus rounds based on the quantity of generated collection symbols and/or the accumulated quantities of the collection symbols in the collection symbol storage areas. In some implementations, when at least a predetermined quantity of collection symbols is accumulated during a round of the bonus game, the gaming system may add additional collection symbols to one or more of the collection symbol sets (e.g., which the gaming system may use to generate collection symbols in future rounds of the bonus game).

The gaming system may further determine and issue various different awards or trigger various different game features based on the accumulated quantities of collection symbols in the collection symbol storage areas. In some implementations, where the gaming system determines that sufficient quantities of collection symbols have not been accumulated in the collection symbol storage areas, the gaming system enables the player to continue playing rounds of the bonus game (e.g., where additional rounds of the bonus game are available) and attempt to accumulate sufficient collection symbols to win one or more of the various different awards or different game features.

As the gaming system accumulates stored collection symbols, the gaming system may also issue other awards or trigger various game features in block 380 based on the accumulated quantities of collection symbols in the one or more collection symbol storage areas. For example, in some implementations, the gaming system may cause certain symbols in a reel-based slot machine game to become wild for a period of time. For example, when the gaming system determines that a quantity of stored collection symbols in a collection symbol storage area associated with a column of symbol display areas exceeds a threshold (e.g., two collection symbols), the gaming system may convert the generated symbols in that column to become wild (e.g., converts the reel into a reel of wild symbols). In some implementations, the symbols can be temporarily converted into new wild symbols. In some implementations, the symbols can remain the same, but the gaming system will evaluate such symbols temporarily as wild symbols. In some implementations, the converted symbols stay wild for three rounds of the bonus game; provided however, other suitable quantities of rounds can be used for the wild period. In some implementations, the gaming system may issue different credit awards corresponding to accumulating different predetermined quantities of collection symbols in the collection symbol storage areas. For example, the gaming system may issue a first award when a first quantity of symbol storage areas accumulate at least a threshold quantity of the stored collection symbols, and may issue a second, larger award when a second, larger quantity of symbol storage areas accumulate another threshold quantity of the stored collection symbols. It should be appreciated that the gaming system may issue other suitable awards based on the accumulated quantities of collection symbols.

In some implementations of reel games, the gaming system may issue different credit awards corresponding to converting different quantities of reels into wild reels. For example, in some implementations, the gaming system may issue a first award when the gaming system converts a first quantity of reels (e.g., three reels) into wild reels. The gaming system may issue a second, larger award when the gaming system converts a second, larger quantity of reels (e.g., four reels, five reels, etc.) into wild reels. Different quantities of wild reels can be associated with different awards. In some implementations, the gaming system may issue the largest available award when the gaming system turns all available reels into wild reels.

At block 382, the processor determines whether the user has any remaining rounds of the bonus game (whether the quantity of remaining rounds is greater than 0). For example, the bonus game may start with a given quantity of rounds. The gaming system may modify the number of rounds based on, for example, quantities of generated collection symbols and/or quantities of accumulated collection symbols in the symbol storage areas. In another example, the gaming system may modify the number of remaining rounds based on the generated symbols, such as provide a quantity of additional rounds when the generated symbols includes a certain symbol or combination of symbols in the base or bonus game. In some implementations, the gaming system may reduce the number of remaining rounds based on awards or other results of prior rounds. For example, the gaming system may reduce the number of remaining rounds when the player has won a certain large award (e.g., a grand prize) or more than a threshold amount of credit. In some implementations, the gaming system may modify the number of remaining rounds based on other factors, such as a wager amount, an input received from the player, a length of a current play, etc.

When the quantity of remaining rounds is greater than 0 (e.g., the player has remaining rounds of the bonus game), the gaming system may decrease the quantity of remaining rounds by 1, and process 300 returns to step 370 to repeat through block 382. Otherwise, when the quantity of remaining rounds is zero, the gaming system updates the player's gaming credit balance in accordance with the award amount(s) determined in block 378 and 380, and processing 300 returns to continuation off page connector D at FIG. 3B.

While blocks 370-384 are described as a bonus game, in some implementations, the bonus game may run independently from a base game (e.g., the bonus game having collection symbols may be executed as a base game).

In some alternative implementations of the base game, the base game may include collection symbols as part of the symbol sets used to generate symbols, such as at block 330. In such alternative implementations, the gaming system may display collection symbols in symbol display areas like any other symbol generated from the symbol sets (e.g., a collection symbol can be displayed like an Ace symbol in displayed symbol display area 410a in FIG. 4A).

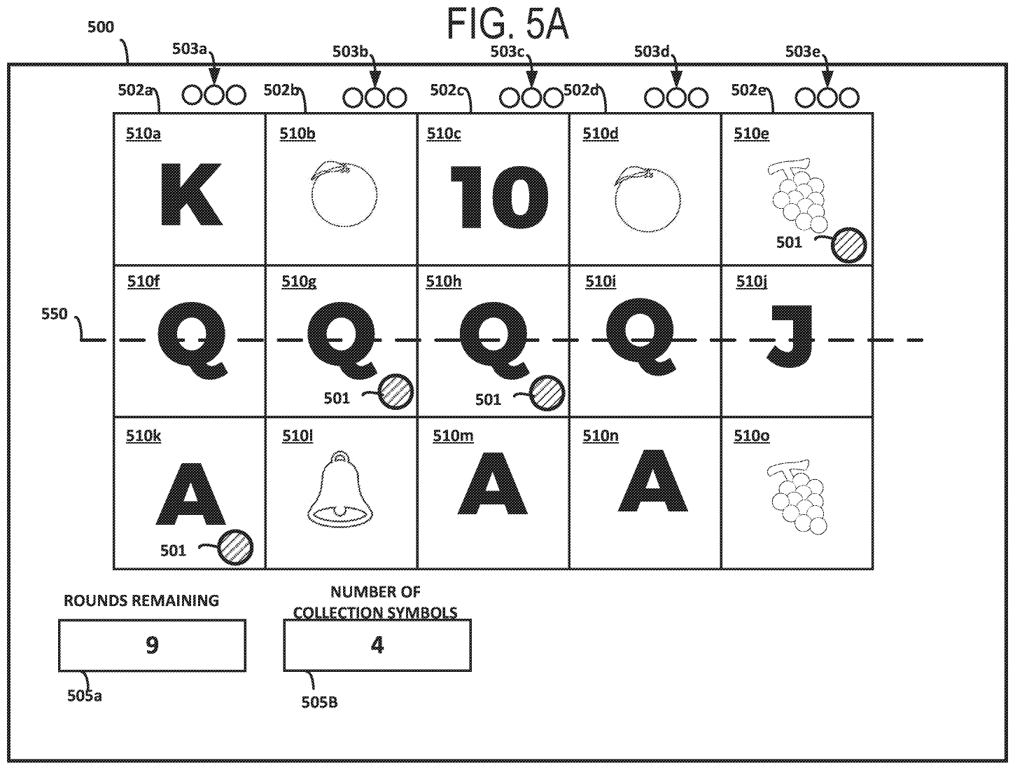

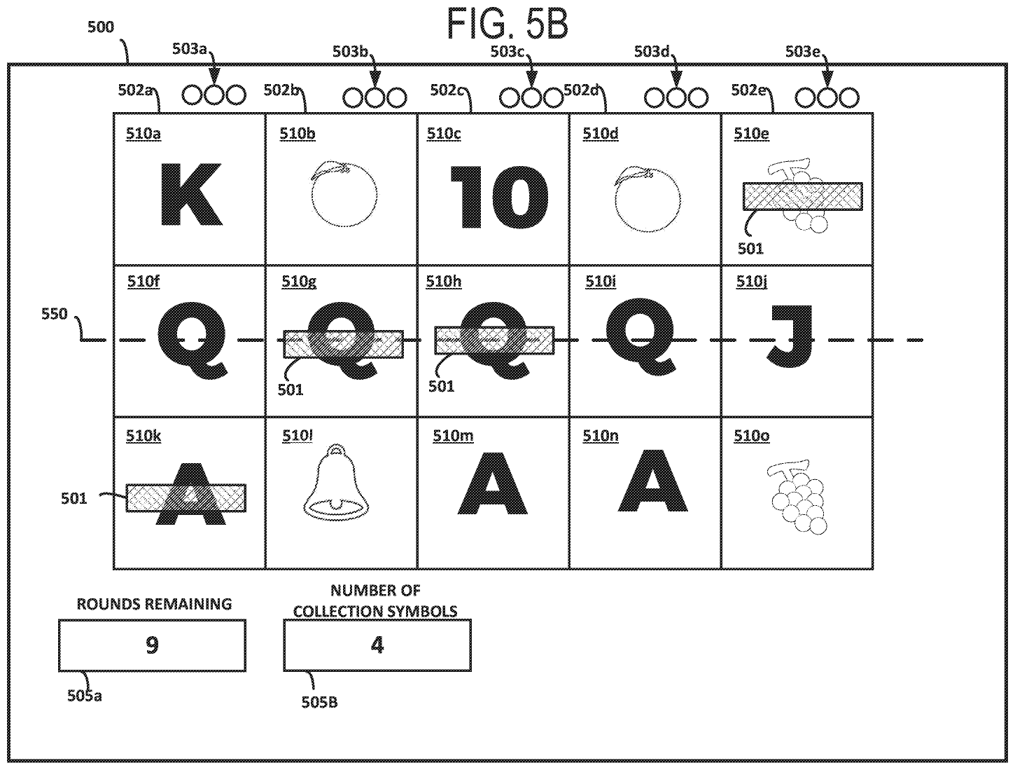

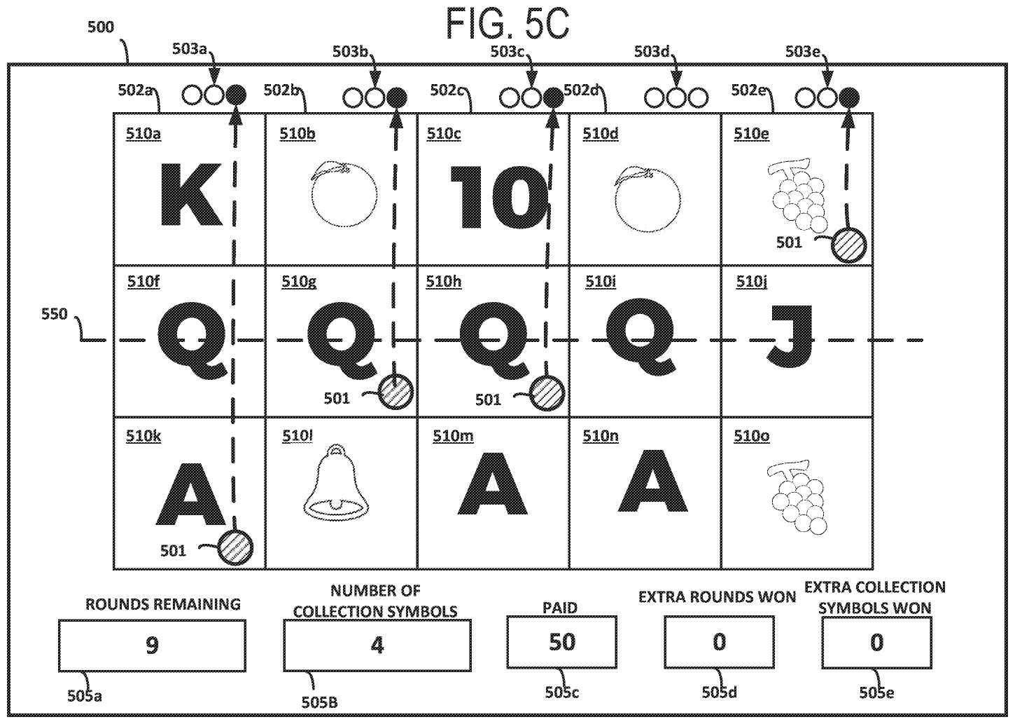

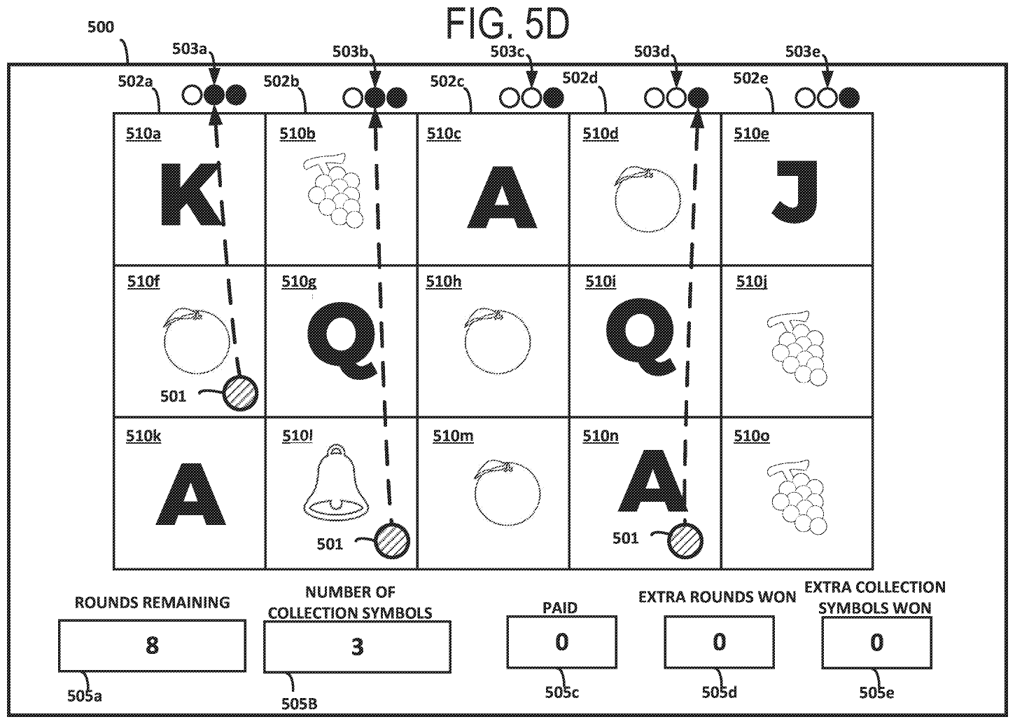

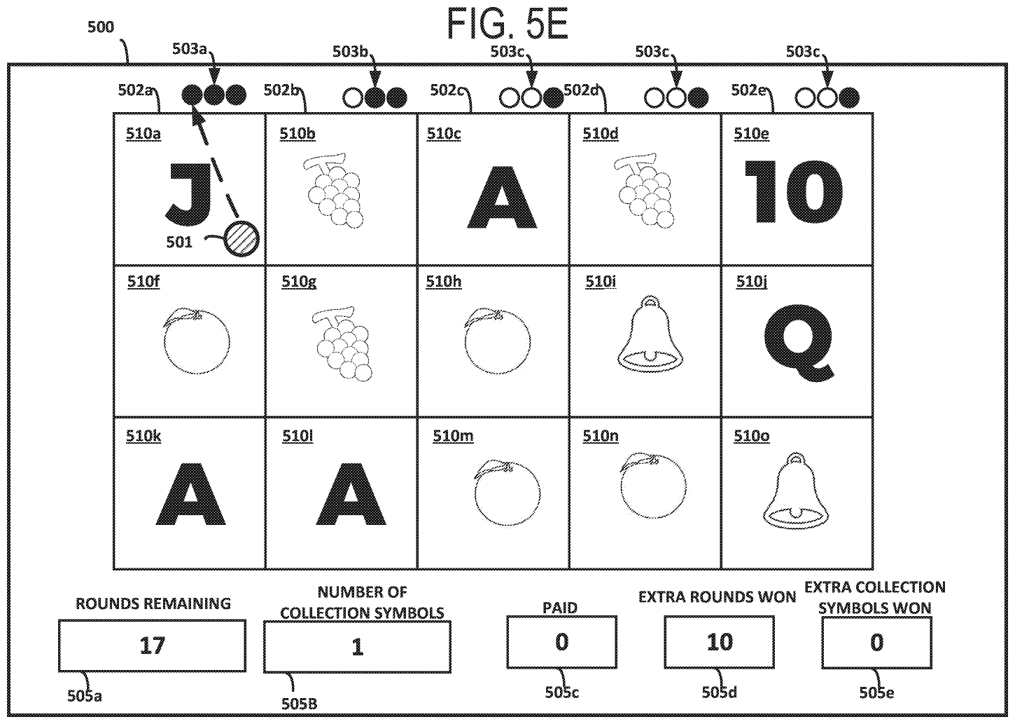

In still other alternative implementations of the base game, the base game may include collection symbols, but not as stand-alone symbols in the symbol sets used to generate symbols for the base game. In some implementations, the collection symbols can be included as side or overlay symbols associated one or more symbols in the symbol sets used to generate symbols. For example, in a symbol set with a defined quantity of Ace symbols, a particular one of the Ace symbols can be associated with a collection symbol. If the gaming system generated the particular one of the Ace symbols associated with the collection symbol, the gaming system may display the Ace symbol in a symbol display area as well as the collection symbol in the same symbol display area. In an alternative implementation, the collection symbols can be generated and displayed for the base game in a manner similar to the discussion of block 372. The display of the example Ace symbol and collection symbol may appear like the symbols in symbol display area 510k of FIG. 5A.

In some implementations, the collection symbols may function as scatter symbols. For example, the gaming system may provide one or more awards based on a generated quantity of collection symbols, regardless of the location in the symbol display areas of the generated collection symbols. In some implementations, the awards associated with collection symbols functioning as scatter symbols can be proportional to a player's wager for the play of the game.

In some implementations where the collection symbols function as scatter symbols in a base game, a generated quantity of collection symbols in the symbol display areas can be used to determine whether a bonus game is triggered. For example, if the gaming system generated three or more collection symbols anywhere in the symbol display area, the gaming system may determine that the bonus game is triggered. It should be appreciated that any suitable quantity of collection symbols can be designated to trigger the bonus game (e.g., one or more, two or more, four or more, etc.).

In some implementations where the collection symbols function as scatter symbols in a base game, the gaming system can determine the quantity of free games or free spins available in the bonus game based on the quantity of scatter symbols generated in a base game. For example, in some implementations, the gaming system may include one collection symbol that is available for the gaming system to generate per reel. In other implementations, the gaming system may include more than one collection symbol that is available for the gaming system to generate per reel. In some implementations, the gaming system may also be configured to provide a certain quantity of free spins or rounds in a bonus game based on the generated collection symbols for a play of a game. In some implementations, the gaming system may provide, for example, 10 free spins in a bonus game if the gaming system generated three collection symbols for a play of a game; 10 free spins in a bonus game and additional available collection symbols in a bonus game (e.g., where the gaming system adds additional available collection symbols to symbol sets for generation in a bonus game) if the gaming system generated four collection symbols for a play of a game; 10 free spins in a bonus game and more additional available collection symbols in a bonus game (than were available when the gaming system generated four collection symbols) if the gaming system generated five collection symbols for a play of a game. It should be appreciated that the quantity of collection symbols generated in a base game and the bonus features (e.g., the quantity of free spins; the quantity of collection symbols made available in a bonus game) provided based on the generated collection symbols may vary in different implementations.

In some implementations where the collection symbols are generated in a base game, the gaming system may visibly mark a symbol display area where a collection symbol was generated. In some implementations, the gaming system may visibly mark a symbol display area by highlighting the symbol display area with colored boxes, halos, or other suitable highlighting around a symbol display area to illustrate that a collection symbol was generated therein. In some implementations where boxes, halos, or other suitable highlighting are used to mark a symbol display area, such markings may be configured to persist for a predetermined quantity of plays of a game (e.g., five plays of the game, or some other suitable quantity of plays of the game). In some implementations, after the predetermined quantity of plays of a game where symbol display areas are visibly marked, the gaming system may determine the quantity of symbol display areas that were visibly marked due to the generation of collection symbols. In some implementations, the gaming system may also be configured to provide a certain quantity of free spins in a bonus game based on the quantity of visibly marked symbol display areas. In some implementations, in addition to the free spins in a bonus game, the gaming system may provide various jackpot awards (e.g., mini, minor, major, etc.), and/or additional available collection symbols in a bonus game in accordance with the determined quantity of visibly marked symbol display areas. In some implementations, the gaming system may provide a larger quantity of free spins, jackpot awards, and collection symbols for larger quantities of visibly marked symbol display areas. In some implementations, the gaming system may remove the visual markings around symbol display area (e.g., boxes, halos, or other suitable highlighting) once the predetermined quantity of plays of a game have passed.

FIGS. 4A and 4B show pictures of a gaming system display illustrating an example based on video slot machine reels in accordance with aspects of the present disclosure for a type of base game. More specifically, FIGS. 4A and 4B illustrate screen shots of one implementation of a gaming system displaying video-based slot machine reels to obtain awards or to trigger generating and storing collection symbols in one or more collection symbol storage areas to obtain enhanced awards. FIG. 4A illustrates one implementation of a game screen 400 that the gaming system 100 may display on a display device of the gaming system. In some implementations, game screen 400 may be displayed on first display 120 of gaming system 100 illustrated in FIG. 1. However, any other suitable display may be used. The game screen 400 displays a set of a virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game screen 400 is merely representative and may have more or fewer game elements (e.g., reels, symbol display areas, symbols, etc.) shown in the game screen 400. It should also be appreciated that other games may be used for the primary or base game.

In some implementations, the reels 402a-402e are each respectively associated with a set of symbols or a symbol set, where each set of symbols includes a number of symbols. The sets of symbols can be associated with the same or different symbols. The sets of symbols may include numbers, letters, geometric figures, symbols, images, characters, blank symbols (e.g., the absence of symbols), animations, transparent symbols (e.g., symbols that permits underlying symbols to be visible), or any other suitable graphical depiction. The symbols in the set of symbols may include pay symbols and special or designated symbols.

In some implementations, at least one predetermined symbol is a triggering symbol for a bonus game that includes generating and storing collection symbols in one or more collection symbol storage areas. However, in some implementations, the bonus game that includes generating and storing collection symbols in one or more collection symbol storage areas is triggered in alternative ways. In one such alternative implementation, the bonus game can be triggered by a bonus controller in communication with the gaming system. In some implementations, at least one triggering symbol must be displayed on the reels during a play of a game to trigger the bonus game that incudes generating and storing collection symbols in one or more collection symbol storage areas. In some implementations, any one of the symbols in the symbol sets can be designated as the predetermined triggering symbol. The triggering symbol may be associated with one function (e.g., triggering the bonus game), but may alternatively be associated with a plurality of different game functions. In certain examples described below, the triggering symbols includes a “T” symbol (e.g., trigger symbol), but is should be appreciated that other triggering symbols or triggering combinations of symbols may be used by the gaming system.

Returning to FIGS. 4A and 4B, the game screen 400 depicts a plurality of symbol display areas (also referred to herein as symbol display positions) 410a, 410b, 410c, 410d, 410e, 410f, 410g, 410h, 410i, 410j, 410k, 410l, 410m, 410n, and 410o. The plurality of symbol display areas can be associated in a manner that provides the appearance of game or slot machine reels. It should also be appreciated that the symbol display areas may not be associated with game reels in some implementations. As illustrated in FIGS. 4A and 4B, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In some implementations, the plurality of symbol display areas that provide the appearance of five game reels may be arranged in a manner that visibly shows three symbol display positions (e.g., symbol display areas) of each of the five game reels (e.g., visible stop positions on the reels). For example, the symbol display areas 410a-410o are each associated with positions on reels 402a-402e, respectively. As shown in FIGS. 4A and 4B, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The gaming system may display fewer or more reels in various implementations. The gaming system may display fewer or more symbol display areas in various implementations.

The arrangement illustrated in the implementation of FIGS. 4A and 4B thus creates a visible display area of the reels 402a-402e having three visible symbol positions (e.g., symbol display areas) for each reel. When viewed together, the illustrated reels 402a-402e appear as a 3-row by 5-column reel array in screen 400. In other implementations, smaller or larger visible areas of the reels may be displayed. That is, the reels 402a-402e may show fewer or a larger number of visible symbol display areas. In some implementations, some symbol display areas can be hidden to hold generated symbols for use when the reels are nudged. While symbol display areas are illustrated with defined boxes, it should be appreciated that in some implementations, the defined boxes are not visible to the player. It should also be appreciated that in some implementations, the symbol display areas are other shapes or not defined shapes and may not be associated with reels.

Each reel 402a-402e may display a plurality of symbols that the gaming system generates from the sets of symbols in their respective symbol display areas, as illustrated in FIGS. 4A and 4B. In some implementations, the individual reels may be shown spinning in one direction to simulate slot machine reels. However, it should be appreciated that the reels may be shown spinning in any suitable direction. The reels may also be shown spinning in different directions in some implementations. In some implementations, the gaming system does not depict reels or spinning symbols and may generate and display symbols for use in a variety of different game formats.

Game screen 400 also includes several information areas and buttons 405a-405i. The information areas and buttons 405a-405i are illustrated in an example configuration and positioning associated with a particular arrangement but may be arranged in any suitable manner in different implementations. In some implementations, game screen 400 may include more or fewer display areas and buttons 405a-405i than illustrated. Information area 405a illustrates an example value of one credit for the game displayed in game screen 400, and in the example shown in FIGS. 4A and 4B, information area 405a illustrates a value of $0.01. Button 405b illustrates a software button that the player can select to view how many credits the player has accumulated and monetary value of these credits if the player wishes to cease playing (e.g., a product of a value per credit shown in information area 405a and a number of remaining credits shown in information area 405c. Information areas 405c illustrate an example of the amount of the player's available credits. In the example shown in FIGS. 4A and 4B, information area 405c illustrates that the player has 1980 available credits after placing a wager. Information area 405d illustrates the amount of credits a player has won. Because FIG. 4A illustrates an example display associated with a start of a play of a game, the information area 405d shows zero credits have been won during the play of the game.

Button 405e illustrates a software button that the player can select to place a bet or wager. It should be appreciated that the functionality of button 405e may also be replicated or replaced with a hardware button on the gaming system 100. Information area 405f illustrates that the player has selected to wager 10 credits per pay line. Button 405g illustrates a software button that the player can select to determine how many pay lines to wager on. It should be appreciated that the functionality of button 405g may also be replicated or replaced with a hardware button on the gaming system 100. Information area 405h identifies a number of pay lines on which the player chooses to wager, and in the example shown in FIG. 4A, information area 405h indicates that the player selected to wager on 20 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on the play of the game. The gaming system may provide a visual indication of the player's credit balance to the player as discussed above in information area 405c.

To initiate the play of the game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever (not shown). The gaming system may deduct the appropriate credits from the player's credit balance (e.g., in information area 405c) after the wager or at any suitable time. For example, the gaming system may deduct a wager per pay line in information area 405f multiplied by a number of pay lines in information area 405h.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In some implementations, the gaming system randomly generates symbols from the associated sets of symbols for reels 402a-402e, respectively. As noted above, the gaming system may rely on random generation performed by a pseudo RNG, a true RNG, or hardware RNG specifically designed for gaming systems. In some implementations, the gaming system may also update the player's credit meter (information area 405c) to reflect the player's available credit balance. As shown in FIG. 4A, the player's credit meter (information area 405c) was decremented by 200 credits from 2180 to 1980 to reflect a prior 200 credit wager the player placed for the play of the game.

The gaming system displays the generated symbols in symbol display areas 410a-410o, as illustrated in FIGS. 4A and 4B. Symbols displayed on reels 402a-402e illustrate the randomly generated symbols from the symbol sets after the reels have stopped spinning. As illustrated in FIGS. 4A and 4B, the gaming system randomly generated and displayed symbols in symbol display areas 410a-410o for reels 402a-402e.

In the example illustrated in FIGS. 4A and 4B, the gaming system generated and displayed Ace symbols (“A”) in symbol display areas 410a, 410c, 410f, 410g, 410h, 410k, and 410m; Orange symbols in symbol display areas 410b and 410d; a Grape symbol in symbol display area 410e; a Queen symbol (“Q”) in symbol display area 410i; a Jack symbol (“J”) in symbol display area 410j; a Bell symbol in symbol display area 410l; a 10 symbol in symbol display area 410n; and a Trigger symbol (“T”) in symbol display area 410o in the game screen 400. It should be appreciated that the displayed symbol combinations are merely for explanatory purposes and the gaming system may randomly generate any suitable combination of symbols based on defined symbol sets associated with the reels 402a-402e.

In some implementations, the gaming system may evaluate the displayed symbols on reels 402a-402e for winning symbol combinations. As noted above, the player may have wagered on one or more pay lines (such as 20 pay lines shown in information area 405h). In some implementations, at least the active (e.g., the wagered on pay lines) are evaluated for winning symbol combinations. Any suitable number of pay lines may be used to evaluate winning symbol combinations.

In some implementations, the gaming system may evaluate the generated symbols on reels 402a-402e for triggering symbols or combinations of symbols that trigger the bonus game that includes generating and storing collection symbols in one or more collection symbol storage areas (hereafter referred to as “triggering symbol combinations”). As noted above, the player may have wagered on one or more pay lines (such as 20 pay lines shown in information area 405h). In some implementations, at least the active (e.g., the wagered on pay lines) are evaluated for triggering symbol combinations. Any suitable number of pay lines may be used to evaluate for the triggering symbol combinations.

In some implementations, the gaming system evaluates the displayed symbols for winning symbol combinations before evaluating the reels for triggering symbol combinations that trigger the bonus game for generating and storing collection symbols. For example, the gaming system may provide the bonus game as an award in the base game, such as when the displayed symbols on reels 402a-402e correspond to one or more of winning symbol combinations. In another example, the gaming system may evaluate the displayed symbols for triggering combinations when based on determining that the displayed symbols on reels 402a-402e do not correspond to any of the winning symbol combinations (e.g., the bonus game may be triggered as a consolation award). In some implementations, the gaming system does not evaluate the displayed symbols for winning symbol combinations until after the reels have been evaluated for triggering symbol combinations that trigger the bonus game.

In some implementations, the gaming system does not evaluate the displayed symbols for triggering symbol combinations that trigger the bonus game. For example, the gaming system may evaluate the displayed symbols for winning symbol combinations, and the gaming system may determine that the bonus game is triggered whenever the displayed symbols correspond to one or more winning symbol combinations. In other examples, the gaming system may determine that the bonus game is triggered based on other factors in addition to or unrelated to the displayed symbols. For example, the gaming system may determine that the bonus game for generating and storing collection symbols in collection symbol storage areas is triggered based on receiving a user input (e.g., a user request received by one or more of the buttons) to request the bonus game. In some implementations, the gaming system may provide the bonus game when the player wagers on one or more pay lines. In other examples, the gaming system may include or be in communication with a bonus controller, and the bonus controller may randomly determine or determine based on a predetermined triggering event (quantity of games played) to trigger or active the bonus game. In some implementations, the gaming system may enable the player to pay or wager to activate the bonus game for generating and storing collection symbols.

In the example shown in FIG. 4B, the gaming system evaluates the displayed symbols for winning symbol combinations and/or triggering symbol combinations in the wagered-on pay lines. In FIG. 4B, the gaming system may determine that reels with winning symbol combinations were displayed based on three Ace symbols appearing on certain wagered pay lines. For example, winning pay line 440a was an active pay line, and three Ace symbols were present along the pay line 440a in display areas 410f, 410g, and 410h. Furthermore, in the example shown in FIG. 4B, the gaming system may determine that the bonus game for generating and storing collection symbols is triggered based on a particular symbol (e.g., the Trigger symbol in symbol display area 410o) appearing on one or more wagered pay lines. For example, pay line 440b may be an active pay line, and the Trigger symbol is present along this pay line 440b in display area 402o. In some implementations, the gaming system can evaluate trigger symbols as scatter symbols. In some implementations, a gaming system may evaluate a trigger symbol independent of any active pay lines.

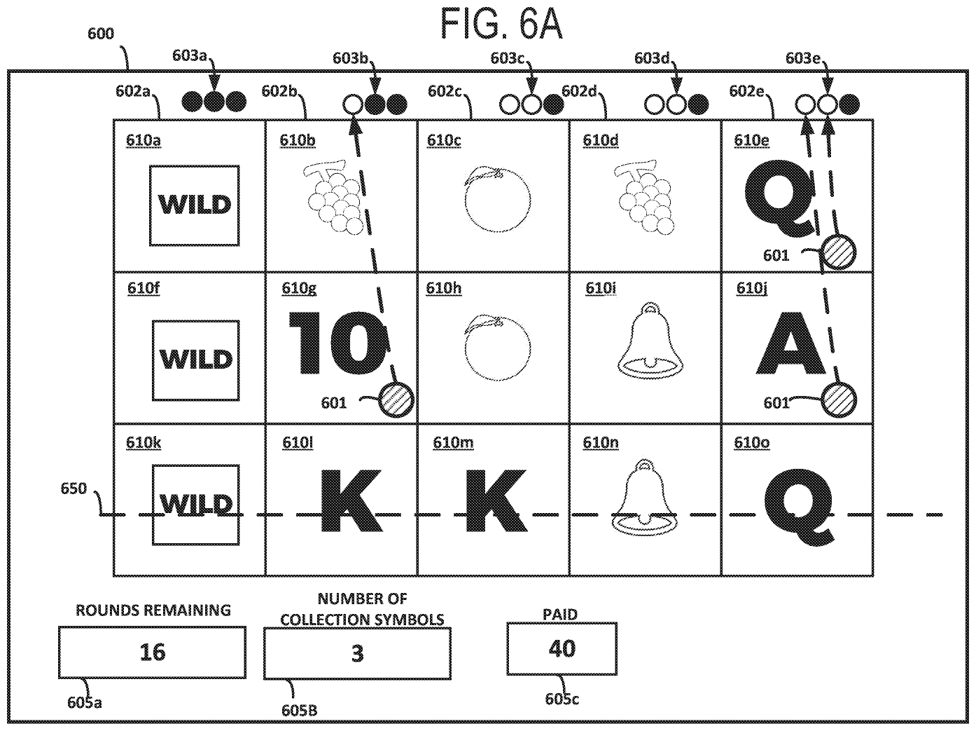

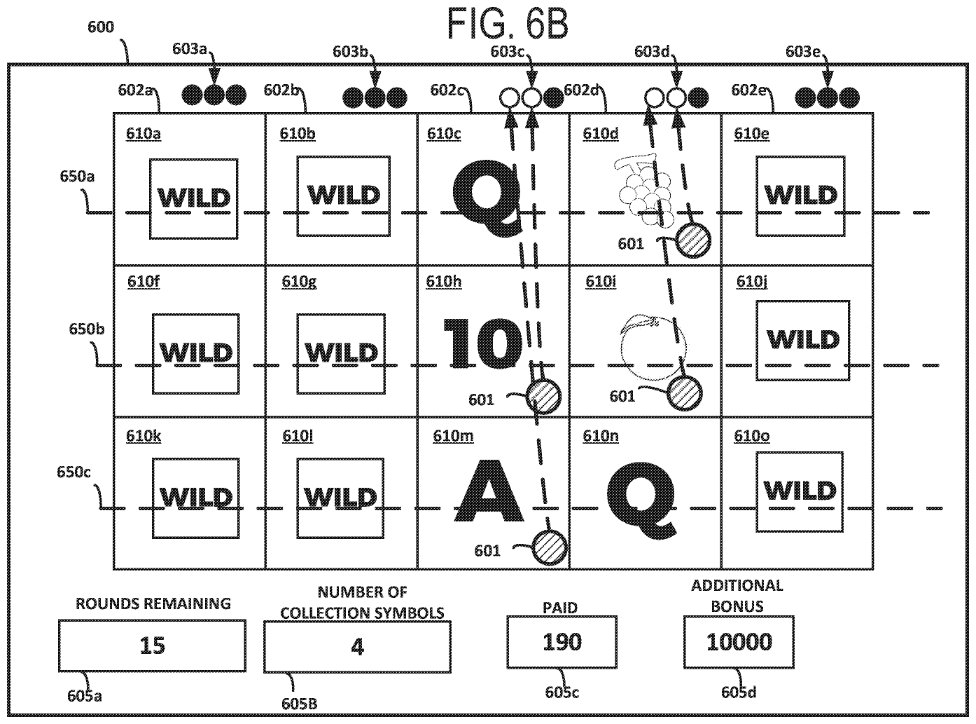

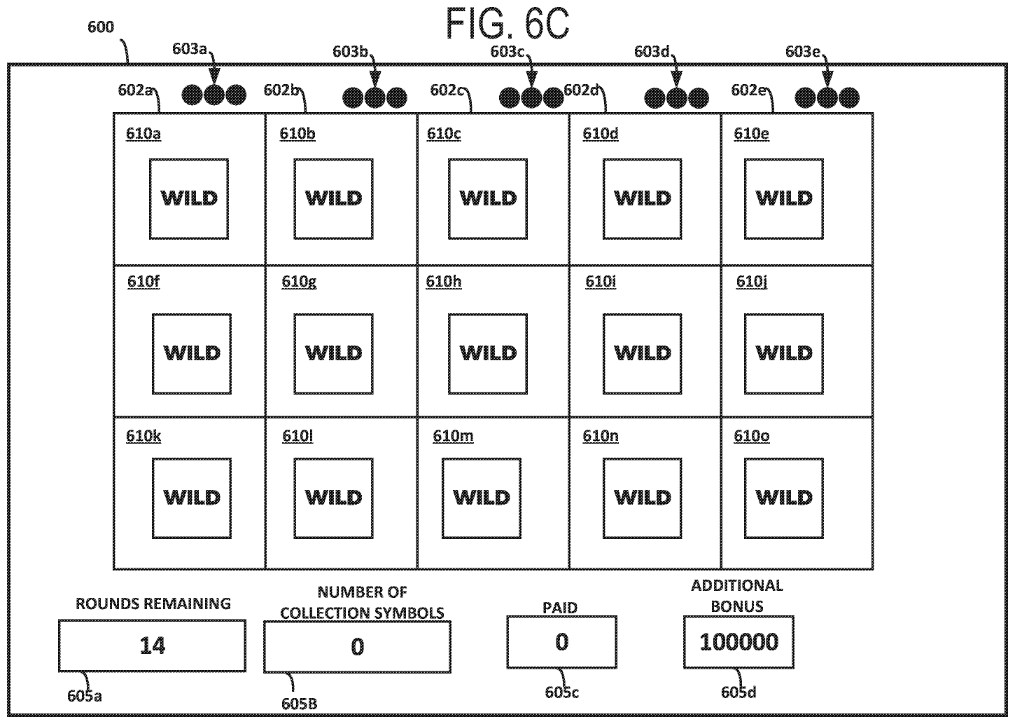

As also illustrated in FIG. 4B, the gaming system determines a payout amount for the play of the base game based on the displayed winning symbol combinations of Ace symbols and an associated pay table (not shown). The gaming system may update the player's gaming credit balance (50 credits in 405d) in accordance with a calculated award amount. In some implementations, the play of the game ends if a bonus game was not triggered. In some implementations, game system implements the bonus game for generating and storing collection symbols in one or more collection symbol storage areas (e.g., as described below with respect to FIGS. 5A-5E and 6A-6C) and may provide additional and/or different awards based on the bonus game.

In some implementations where the bonus game is not triggered, the player may continue the gaming session (e.g., another consecutive play of the game) by executing another play of the game. That is, the player may place another wager and start a new play of the game as noted above. However, continued game play is dependent on the number of credits remaining in the player's credit balance. The player may also choose to cash out. In such an instance, the gaming system provides the player a value based on the player's credit balance using any of the value items discussed above (bills, coins, vouchers, etc.).

FIGS. 5A-5E show pictures of a gaming system display illustrating a bonus game in accordance with aspects of the present disclosure after being triggered from a base game (e.g., FIG. 4A-4B). For the sake of brevity, FIGS. 5A-5E share features similar to the features already discussed above in connection with FIGS. 3A, 3B, 4A, and 4B and such similar features will not be described again. FIGS. 5A-5E illustrate screen shots of one implementation of a gaming system that provides a bonus game for generating and storing collection symbols. FIGS. 5A-5E illustrate certain implementation of a game screen 500 that the gaming system 100 may display on a display device of the gaming system. In some implementations, game screen 500 may be displayed on the first display 120 or a second display 130 of gaming system 100 illustrated in FIG. 1. However, any other suitable display may be used.

The game screen 500 displays a set of a virtual video slot machine reels 502a, 502b, 502c, 502d, and 502e, as illustrated in FIG. 5A, for a bonus game. Virtual video slot machine reels 502a, 502b, 502c, 502d, and 502e may correspond to virtual video slot machine reels 402a, 402b, 402c, 402d, and 402e in the base game as described above with respect to FIG. 4A. It should be appreciated that the game shown in game screen 500 is merely representative and may have more or fewer game elements (e.g., reels, symbol display areas, symbols, etc.) than shown in the game screen 500. In some implementations, the reels 502a-502e are each respectively associated with a set of symbols or a symbol set, where each set of symbols includes a number of symbols. In some implementations, the symbol sets for the reels 502a-502e can be the same as the symbol sets used in the base game discussed in FIG. 4A-4B (e.g., same symbols, same quantity of symbols). In some implementations, some of the symbol sets for the reels 502a-502e can be the same as some of the symbol sets used in the base game discussed in FIG. 4A-4B. For example, some of the symbols can be different, some quantities of some symbols can be different, some symbol sets may have different quantities of symbols, etc. In some implementations, all of the symbol sets for the reels 502a-502e can be different from the symbol sets used in the base game discussed in FIG. 4A-4B.

Continuing with FIG. 5A, the game screen 500 depicts a plurality of symbol display areas (also referred to herein as symbol display positions) 510a, 510b, 510c, 510d, 510e, 510f, 510g, 510h, 510i, 510j, 510k, 510l, 510m, 510n, and 510o, which may correspond to symbol display areas 410a-410o in FIG. 4A. For example, the plurality of symbol display areas 510a-510o can be associated in a manner that provides the appearance of game or slot machine reels. It should also be appreciated that the symbol display areas may not be associated with game reels in some implementations. As illustrated in FIG. 5A, the symbol display areas 510a-510o may be associated in a manner that provides the appearance of a set of five slot machine game reels. In some implementations, the plurality of symbol display areas that provide the appearance of five game reels may be arranged in a manner that visibly shows three symbol display positions (e.g., symbol display areas) of each of the five game reels (e.g., visible stop positions on the reels). For example, the symbol display areas 510a-510o are each associated with positions on reels 502a-502e, respectively. As shown in FIGS. 5A and 5B, symbol display areas 510a, 510f, and 510k are associated with reel 502a; symbol display areas 510b, 510g, and 510l are associated with reel 502b; symbol display areas 510c, 510h, and 510m are associated with reel 502c; and symbol display areas 510d, 510i, and 510n are associated with reel 502d; and symbol display areas 510e, 510j, and 510o are associated with reel 502e. The gaming system may display fewer or more reels in various implementations.

The arrangement illustrated in the implementation of FIG. 5A thus creates a visible display area of the reels 502a-502e having three visible symbol positions for each reel. When viewed together, reels 502a-502e appear as a 3-row by 5-column reel array in screen 500. In other implementations, smaller or larger visible areas of the reels may be displayed. That is, the reels 502a-502e may show fewer or a larger number of visible symbol display areas. In some implementations, some symbol display areas can be hidden to hold generated symbols for use when the reels are nudged. While symbol display areas are illustrated with defined boxes, it should be appreciated that in some implementations, the defined boxes are not visible to the player. It should also be appreciated that in some implementations, the symbol display areas are other shapes or not defined shapes and may not be associated with reels. Each reel 502a-502e may display a plurality of symbols that the gaming system generates from the sets of symbols in their respective symbol display areas, as illustrated in FIG. 5A.

In FIG. 5A, the gaming system is depicted as having generated four collection symbols 501 in symbol display area 510e associated with reel 502e, symbol display area 510g associated with reel 502b, symbol display area 510h associated with reel 502c, and symbol display area 510k associated with reel 502a. In FIG. 5A, the collection symbols 501 are shown as coins. It should be appreciated, however, that the collection symbols 501 may be illustrated as various other suitable text, images, symbols, etc. For example, as shown in FIG. 5B, the gaming system may present the collection symbols 501 as horizontal stripes that are overlaid on the generated symbols in symbol display areas 510e, 510g, 510h, 510k.

As further shown in FIG. 5A, a winning pay line 550 is identified in a middle row of the reel array in screen 500. For example, in FIG. 5A, the gaming system may determine that reels with winning symbol combinations were displayed based on four Queen (Q) symbols appearing on certain wagered pay lines. For example, winning pay line 550 was an active pay line, and four adjacent Queen symbols were present along the pay line 550 in display areas 510f, 510g, 510h, and 510i.

Game screen 500 in FIG. 5A also includes an information area 505a identifying a number of remaining rounds in a bonus game (shown as 9 to indicate that the bonus game initially had 10 rounds, and the game screen 500 is associated with results of a first round), and an information area 505b identifying a number of collection symbols (shown as 4 to correspond to collection symbols 501 in symbol display areas 510e, 510g, 510h, and 510k) that were generated and are displayed during the present round. The information areas 505a-505b are illustrated in an example configuration and positioning associated with a particular arrangement, but may be arranged in any suitable manner in different implementations, and in some implementations, game screen 500 may include more or fewer display areas and buttons 505a-505b than illustrated. For example, the game screen 500 may also have the same or similar information areas shown in FIG. 4A.

The game screen 500 may also include one or more collection symbol storage areas 503a, 503b, 503c, 503d, and 503e. As shown in FIG. 5A, the gaming system may position each of the collection symbol storage areas 503a, 503b, 503c, 503d, and 503e to be near an associated reel 502a, 502b, 502c, 502d, and 502e. In some implementations, the gaming system accumulates stored collection symbols in the symbol storage areas 503a, 503b, 503c, 503d, and 503e. For example, when the gaming system generates collection symbols in reel 502a and reel 502a is associated with collection symbol storage area 503a, the gaming system may store the generated collection symbols in collection symbol storage area 503a. Similarly, when the gaming system generates collection symbols in reel 502d and reel 502d is associated with collection symbol storage area 503d, the gaming system may store the generated collection symbols in collection symbol storage area 503d. As described below, the gaming system may issue various awards or trigger various game features based on the accumulated quantities of collection symbols in the symbol storage areas 503a, 503b, 503c, 503d, and 503e. In the example shown in FIG. 5A, the symbol storage areas 503a, 503b, 503c, 503d, and 503e are all blank (depicted as open circles) to correspond to a situation in which the bonus game has just started, and no collection symbols are stored in the symbol storage areas 503a, 503b, 503c, 503d, and 503e from prior rounds of the bonus game. In some implementations, the collection symbol storage areas 503a-503e can be placed in other suitable locations on the game screen 500 or shown in other physical displays.

Although shown as being associated with respective reels (or columns), the collection symbol storage areas 503a, 503b, 503c, 503d, and 503e may be associated with other portions of the symbol display areas 510a-510o too. For example, certain collection symbol storage areas 503a-503e may accumulate and store collection symbols generated on certain rows, pay lines, corners, or other groupings of the symbol display areas 510a-510o.

As shown in FIG. 5C, the gaming system accumulates and stores the generated collection symbols 501 in the symbol storage areas 503a, 503b, 503c, 503d, and 503e. For example, the gaming system moves (as indicated by the dashed lines) and stores collection symbols 501 generated in symbol display areas 510e, 510g, 510h, 510k to storage areas 503a, 503b, 503c, and 503e associated with reels 502a, 502b, 502c, and 502e corresponding to symbol display areas 510e, 510g, 510h, 510k where the collection symbols 501 were generated. In this example, the gaming system moves and stores collection symbols 501 to storage areas 503a, 503b, 503c, and 503e. Each of the storage areas 503a, 503b. 503c, and 503e includes a graphical indication or counter identifying the respective quantities of stored collection symbols 501 (depicted as black circles for each of the stored collection symbols 501). In some implementations, the gaming system stores any generated collection symbol in an associated collection symbol storage area regardless of where the collection symbol is displayed in the symbol display areas. In some implementations, the gaming system stores generated collection symbols in an associated collection symbol storage area when the generated collection symbols are generated in symbol display areas that also had a winning symbol combination or was part of an active pay line. It should be appreciated that other suitable qualifying game events can be used to determine whether the gaming system stores a generated collection symbol. In some implementations, the gaming system removes displayed collection symbols from the symbol display areas once the round is complete or once the gaming system adds a displayed collection symbol in symbol display area to the appropriate collection symbol storage area.

In some implementations, when the gaming system removes a displayed collection symbol for storage, the gaming system removes the collection symbol from the collection symbol set. In some implementations, the gaming system cannot generate the removed collection symbol once the collection symbol is removed from a collection symbol set. In other implementations, the gaming system does not remove a stored collection symbol from a collection symbol set (e.g., enabling the gaming system to generate a collection symbol from a collection symbol set more than once in a bonus game).

In some implementations, the gaming system may implement a scatter game in which various awards or other game features are triggered based on a generated quantity of generated collection symbols 501, regardless of the location of the generated collection symbols 501 in the symbol display areas 510a-510o. For example, the game screen 500 in FIG. 5C may include an information area 505c identifying an award to be paid (shown as 50) based on the combination of Queen symbols in winning pay line 550. The gaming system may optionally modify the award associated with winning pay line 550 based on the quantity of generated collection symbols (e.g., shown as 4 in FIG. 5C) in some implementations. For example, the gaming system may optionally increase the award associated with winning pay line 550 by a percentage determined based on the quantity of generated collection symbols in screen 500 during the current bonus game round.

In some implementations, the gaming system provides the player with a given number of extra rounds of the bonus game based on the quantity of generated collection symbols 501 in screen 500. In some implementations, the gaming system provide the player with a predetermined number of extra rounds when the quantity of accumulated collection symbols 501 in a particular collection symbol storage area exceeds a threshold (e.g., 3 or more). In some implementations, the gaming system may provide the player with extra rounds and other awards as the player obtains more accumulated collection symbols in a particular collection symbol storage area. In an alternative implementation, the gaming system provides the player with a predetermined number of extra rounds when the quantity of generated collection symbols 501 exceeds a threshold (e.g., 4 or more) without regard to accumulating collection symbols in a particular collection symbol storage area. In some implementations, screen 500 in FIG. 5C includes an information area 505d identifying that extra rounds of the bonus game are awarded to the player. In the illustrated example, the extra rounds won is zero because none of the collection symbol storage areas obtained a threshold quantity of collection symbols. In another example, the gaming system can provide the player with a number of extra rounds that is proportional to or otherwise determined based on the quantity of accumulated collection symbols 501 in a particular collection symbol storage area.

In some implementations, the gaming system provides the player with additional collection symbols for one or more future rounds of the bonus game based on the quantity of accumulated collection symbols 501 in a particular collection symbol storage area in screen 500. In some implementations, the extra collection symbols are available for a predetermined quantity of extra rounds. In some implementations, the extra collection symbols are available until the bonus game ends. In some implementations, the gaming system provides the player with a predetermined number of extra collection symbols 501 that the gaming system adds to one or more of the collection symbol sets when the quantity of accumulated collection symbols 501 exceeds a threshold (e.g., 4 or more). In some implementations, when additional collection symbols are added to a collection symbol set, the gaming system can be configured to be more likely to generate collection symbols from the collection symbol sets for display on the symbol display areas due to the increased quantity of collection symbols in the collection symbol set. For example, screen 500 in FIG. 5c also includes an information area 505e that identifies additional collection symbols 501 that are provided to the player when the condition is triggered. In another example, the gaming system provides the player with a number of extra collection symbols 501 that is proportional to or otherwise determined based on the quantity of generated collection symbols 501. The features of adding collection symbols to the collection symbol sets can be used alone or in combination with providing additional rounds of the bonus game based on accumulated quantities of collection symbols in a particular collection symbol storage area.

In some implementations, the gaming system provides the player with a predetermined number of extra rounds and/or provides the player with additional collection symbols based on the quantity of generated collection symbols 501 in a certain subset of the reels 502a-502e. For example, the gaming system may award the player with extra rounds, additional collection symbols, or other awards based on the quantity of generated collection symbols 501 in certain ones of the reels 502a-502e that are preselected, randomly selected by the gaming system, and/or selected by the player. For example, the gaming system may determine the quantity of generated collection symbols 501 in certain ones of the reels 502a-502e associated with active pay lines.

Continuing with a hypothetical next round (e.g., the second round) in this example, FIG. 5D, shows that the gaming system generated replacement symbols for the symbol display areas 510a-510o from the symbol sets and the gaming system also generated three new collection symbols 501 in symbol display areas 510f, 510l, and 510n.

Game screen 500 in FIG. 5D shows information area 505a indicating the number of remaining rounds is adjusted since down FIG. 5C (shown as 8 to indicate that one round has been used since display 500 in FIG. 5C). Game screen 500 in FIG. 5D shows information area 505b identifying a number of collection symbols (shown as three to correspond to collection symbols 501 that are displayed in symbol display areas 510f, 510l, and 510n).

As also shown in FIG. 5D, the gaming system accumulates and stores the collection symbols 501 in the symbol storage areas 503a, 503b, and 503d, respectively. For example, the gaming system moves (e.g., as indicated by the dashed lines) and stores collection symbols 501 in symbol display areas 510f, 510l, and 510n to storage areas 503a, 503b, and 503d associated with reels 502a, 502b, and 502d. For example, storage areas 503a and 503b show two stored collection symbols 501 obtained on reels 502a and 502b during the round displayed in FIG. 5C and another round displayed in FIG. 5D. Storage areas 503c and 503e continue to store and display a single collection symbol 501 associated with the prior round displayed in FIG. 5C. Further, storage area 503d shows one stored collection symbol 501 obtained on reel 502d during current round displayed in FIG. 5D.

In FIG. 5D, the gaming system also evaluated the replacement plurality of symbols displayed in the symbol display areas 510a-510o for winning symbol combinations. In the illustrated example of FIG. 5D, no winning symbol combinations were displayed, so information area 505c reflects a value of zero. Similarly, information areas 505d and 505e have not changed in this example because the gaming system did not award the player with extra rounds of the bonus game or extra collection symbols 501 since the quantity of accumulated collection symbols 501 in the collection symbol storage areas 503a-503e did not exceeds a predetermined threshold (e.g., 3 or more, or some other suitable number).

Continuing with a hypothetical next round (e.g., the third round) in this example, FIG. 5E, shows that the gaming system generated replacement symbols for the symbol display areas 510a-510o from the symbol sets and the gaming system also generated one new collection symbol 501 in symbol display area 510a on reel 502a.

As shown in FIG. 5E, the gaming system moves (e.g., as indicated by the dashed lines) and stores the displayed collection symbol 501 in symbol display area 510a to storage area 503a associated with reel 502a. In this example, storage areas 503a shows that three collection symbols 501 generated on reel 502a were accumulated and stored during the bonus game. In some implementations, the predetermined threshold for triggering an award is collecting at least three collection symbols in one particular collection symbol storage area. For example, one award is the gaming system providing the player with a predetermined quantity of additional free rounds of the bonus game (e.g., free games or free spins in some applicable cases). As shown in FIG. 5E, information area 505d reflects that the gaming system issued to the player 10 extra rounds of the bonus game. Game screen 500 in FIG. 5E further shows information area 505a indicating the number of remaining rounds is adjusted since FIG. 5D (e.g., shown as 17 to indicate that one round has been used since display 500 in FIG. 5D, but 10 extra rounds were added as an award in FIG. 5E). Game screen 500 in FIG. 5E also shows information area 505b identifying a number of collection symbols (e.g., shown as 1 to correspond to collection symbol 501 that is generated in symbol display areas 510a). In some implementations, the gaming system may provide one or more extra collection symbols in addition to the free rounds if the player has accumulated four or more collection symbols in a particular collection symbol storage area. In the illustrated example of FIG. 5E, the gaming system did not provide extra collection symbols. In some implementations, the gaming system may provide other features associated with accumulating a predetermined quantity of collection symbols in a particular collection symbol storage area. One such example is described below with respect to FIG. 6A.

In FIG. 5E, the gaming system also evaluated the replacement plurality of symbols displayed in the symbol display areas 510a-510o for winning symbol combinations. In the illustrated example of FIG. 5E, no winning symbol combinations are displayed, so information area 505c did not increase from the prior round of the bonus game.

FIGS. 6A-6C, which continues the bonus game from FIG. 5E, show pictures of a gaming system display illustrating a bonus game in accordance with aspects of the present disclosure. For the sake of brevity, FIGS. 6A-6C share features similar to the features already discussed above in connection with FIGS. 3A, 3B, 4A, 4B, and 5A-5E, and such similar features will not be described again. FIGS. 6A-6C illustrate screen shots of one implementation of a gaming system that provides a bonus game for generating and storing collection symbols. FIGS. 6A-6C illustrate a certain implementation of a game screen 600 that the gaming system 100 may display on a display device of the gaming system. In some implementations, game screen 600 may be displayed on the first display 120 or a second display 130 of gaming system 100 illustrated in FIG. 1. However, any other suitable display may be used.

As previously described with respect to FIG. 5E, the gaming system stored three collection symbols 501 in collection symbol storage area 503a associated with reel 502a. Similarly, collection symbol storage areas 603a shows that three collection symbols 601 stored in the collection symbol storage area 603a. It should be appreciated, however, that the collection symbol storage areas 603a-603e may store fewer, more, or different numbers of collection symbols 601.

In some implementations, the full collection symbol storage area 603a may trigger various game features in the game system such as the features discussed above. In some implementations, when the gaming system determines that a particular collection symbol storage area accumulates a predetermined threshold of collection symbols, the gaming system may in addition to or in the alternative to the features discussed herein, convert symbols in an associated reel into Wild symbols. For example, in FIG. 6A, the gaming system may convert one or more of the symbols in a reel 602a, associated with full collection symbol storage area 603a, into Wild symbols. The reel may remain wild symbols for one or more rounds of the bonus game. In some implementations, the gaming system may keep the converted symbols as Wild symbols for three rounds of the bonus game. For example, these symbols or reels do not obtain new replacement symbols for the duration of the Wild conversion period. In some implementations, the gaming system will keep converted symbols as Wild symbols for a quantity of rounds of the bonus game based on a quantity of collection symbols stored in the collection symbol storage area. For example, because collection symbol storage area 603a includes three collection symbols, the gaming system may keep the converted symbols as Wild symbols for three rounds of the bonus game. If collection symbol storage area 603a included four collection symbols (not shown), the gaming system may keep the converted symbols as Wild symbols for four rounds of the bonus game. In some implementations, the gaming system includes a Wild symbol countdown counter associated with one or more reels to determine when Wild symbols in one or more reels should be converted back to non-Wild symbols. The initial counter value for the Wild symbol countdown counter may be based on stored collection symbols in a collection symbol storage area. In some implementations, after a round of a bonus game where symbols were converted to Wild symbols on a particular reel, the gaming system may reduce the Wild symbol countdown counter by one or some other suitable number. Once a Wild symbol countdown counter reaches a threshold number, the gaming system may convert Wild symbols on the particular reel associated with the Wild symbol countdown counter back into non-Wild symbols. It should be appreciated that the gaming system can keep the converted symbols as Wild symbols for other suitable quantity of rounds of the bonus game and based on other suitable criteria. In some implementations, when a reel or a symbol is converted temporarily into Wild, the gaming system does not generate new replacement symbols and does not generate collection symbols in the symbol display areas of the converted symbols.

In some implementations, by reducing the symbols generated (e.g., by keeping converted Wild symbols for a certain quantity of rounds) for the bonus game, the gaming system reduces the amount of processor and memory resources used during a round of the bonus game. By reducing the amount of game elements generated, the efficiency of the gaming system is improved because less memory and less processing power are used during the gaming system's determination execution a bonus round over typical reel based bonus games. This machine efficiency also translates into faster game play because less time is used to complete a play of the game because few processing cycles are used. When such efficiency improvements are made and applied to the hundreds and thousands of plays of the game that are made on a casino floor for the disclosed gaming system, the new gaming system will provide casino game operators sizable gains in gaming system efficiency, which is a technological improvement.

As used herein, a Wild symbol may refer to a symbol that may vary when evaluating the generated symbols to complete one or more winning combinations with other, remaining symbols. For example, FIG. 6A shows that a Wild symbol at symbol display area 610k may be interpreted as a King (K) symbol to form a winning symbol combination along pay line 650 with other King symbols at symbol display areas 610l and 610m. Thus, information area 605c may indicate a hypothetical credit award of 40 from the winning symbol combination of King symbols on pay line 650.

In FIG. 6A, corresponding to a hypothetical fourth round in this example, a game screen 600 also shows generated replacement symbols for the symbol display areas 610a-610o and generated collection symbols 601 in symbol display area 610g, associated with reel 602b, and in symbol display areas 610e and 610j associated with reel 602e. Game screen 600 in FIG. 6A further shows information area 605a indicating the number of remaining rounds is adjusted since FIG. 5E (e.g., shown as 16 to indicate that one round has been used since display 500 in FIG. 5E). Game screen 600 in FIG. 6A shows information area 605b identifying a quantity of collection symbols (e.g., shown as 3 to correspond to collection symbols 601 generated in symbol display areas 610e, 610g, and 610j). As also in FIG. 6A, the gaming system moves (e.g., as indicated by the dashed lines) and stores collection symbols 601 in symbol display areas 610e, 610g, and 610j to corresponding storage areas 603b (e.g., associated with reel 602b) and 603e (e.g., associated with reel 602e), respectively.

As shown in FIG. 6B, storage areas 603b and 603e show that three collection symbols 601 distributed to reels 602b and 602e are accumulated and stored. The gaming system may convert symbols in reels 602b and 602e, associated with collection symbol storage areas 603b and 603e, to Wild symbols for accumulating threshold quantities of collection symbols. The symbols in reel 602a remain as Wild symbols because the reel is still in its Wild period. It should be appreciated, that while the gaming system may award extra rounds of the bonus game due to the accumulated quantities of collection symbols in collection symbol storage areas 603b and 603e, for brevity, these features are not illustrated.

FIG. 6B further shows that Wild symbols at symbol display areas 610a, 610b, 610e, 610f, 610g, 610j, 610k, 610lm and 610o may be interpreted as various symbols to form winning symbol combinations along pay lines 650a, 650b, and 650c with other replacement symbols associated with reels 602c and 602d. Thus, information area 605c may indicate a hypothetical credit award of 190 from the winning combination of symbols on pay line 650a-650c.

In FIG. 6B, corresponding to a hypothetical fifth round in this example, a game screen 600 also shows generated collection symbols 601 in symbol display area 610h and 610m associated with reel 602c, and in symbol display areas 610d and 610i associated with reel 602d. Game screen 600 in FIG. 6B further shows information area 605a indicating the number of remaining rounds is adjusted since FIG. 6A (e.g., shown as 15 to indicate that one round has been used since display 600 in FIG. 6A). It should be appreciated that in some implementations, the rounds remaining may have increase due to the quantities of accumulated collection symbols. Game screen 600 in FIG. 6B shows information area 605b identifying a number of collection symbols (e.g., shown as 4 to correspond to collection symbols 601 generated in symbol display areas 610d, 610h, 610i, and 610m). As also in FIG. 6B, the gaming system moves (e.g., as indicated by the dashed lines) and stores collection symbols 601 to storage areas 603c (e.g., associated with reel 602c) and 603d (e.g., associated with reel 602d).

As further shown in FIG. 6B, the conversion of three or more reels (e.g., reels 602a, 602b, and 602e) into Wild symbols may further trigger an additional bonus (e.g., one or more bonus awards), as identified in information area 605d as 10,000 credits. Furthermore, the gaming system may award a relatively smaller award for three converted reels 602 into Wild symbols, a relatively larger award for converting four reels 602 into Wild symbols, and an even larger award (e.g., a grand prize) for converting five reels 602 into Wild symbols. It should be appreciated that any suitable awards or prizes can be provided.

In FIG. 6C, corresponding to a hypothetical sixth round in this example, a game screen 600 also shows that all of the collection symbol storage areas 603a-603e have accumulated and stored three collection symbols 601. In some implementations, the gaming system may convert symbols in all of the corresponding reels 602a-602e, into Wild symbols. Screen display 600 in FIG. 6C further shows information area 605a indicating the number of remaining rounds is adjusted since FIG. 6C (e.g., shown as 14 to indicate that one round has been used since game screen 600 in FIG. 6B). Game screen 600 in FIG. 6C shows information area 605b identifying a quantity of collection symbols (e.g., shown as 0 to indicated that no collection symbols 601 are generated in the symbol display areas 610a-610o).

As further shown in FIG. 6C, the conversion of all five reels 620 to Wild symbols may further trigger an additional bonus (e.g., one or more a grand prize award), as identified in information area 605d as 100,000 credits. In some implementations, when the player wins a top award (e.g., the grand prize), the bonus game ends and the gaming system calculates the player's final award for the rounds of the bonus game.

In alternative implementations (not shown), if the player has not collected the predetermined threshold quantities of collection symbols in all of the collection symbol storage areas, the gaming system may continue to play rounds of the bonus game while the player had remaining rounds. In some implementations, when the bonus game ends after the player uses all available rounds of the bonus game, the player may have accumulated collection symbols in one or more collection symbol storage areas that did not result in an award (e.g., unused collection symbols). In some implementations, the gaming system may evaluate these stored but “unused” collection symbols as scatter symbols in accordance with an applicable pay table and provide the player with one or more scatter symbol awards associated with the “unused” collection symbols.

In some implementations, when the gaming system provides certain awards associated with accumulating a predetermined quantity of collection symbols in a collection symbol storage area, the gaming system may reset or clear that collection symbol storage area. This may enable the player to rebuild the collection symbol storage area in some implementations.

In some implementations of a bonus game (e.g., such as shown in FIGS. 5A-5E and FIGS. 6A-6C), the bonus game may include collection symbols as part of the symbol sets used to generate symbols, such as at block 370. In such alternative implementations, the gaming system may display collection symbols in symbol display areas like any other symbol generated from the symbol sets (e.g., a collection symbol can be displayed like a King symbol in displayed symbol display area 510a in FIG. 5A).

In still other implementations of the bonus game, the bonus game may include collection symbols, but not as stand-alone symbols in the symbol sets used to generate symbols for the bonus game. In some implementations, the collection symbols can be included as side or overlay symbols associated with one or more symbols in the symbol sets used to generate symbols. For example, in a symbol set with a defined quantity of Queen symbols, a particular one of the Queen symbols can be associated with a collection symbol. If the gaming system generated the particular one of the Queen symbols associated with the collection symbol, the gaming system may display the Queen symbol in a symbol display area as well as the collection symbol in the same symbol display area. In an alternative implementation, the collection symbols can be generated and displayed for the bonus game in a manner similar to the discussion of block 372. The display of the example Queen symbol and collection symbol may appear like the symbols in symbol display area 510g of FIG. 5A. In some implementations of the bonus game may include collection symbols as stand-alone symbols in the symbol sets used to generate symbols for the bonus game and as side or overlay symbols associated with one or more symbols in the symbol sets used to generate symbols.

In some implementations, the collection symbols may function as scatter symbols in the bonus game. For example, the gaming system may provide one or more awards based on a generated quantity of collection symbols, regardless of the location in the symbol display areas of the generated collection symbols. In some implementations, the awards associated with collection symbols functioning as scatter symbols can include additional free games or additional rounds of a bonus game as part of a play of a game.

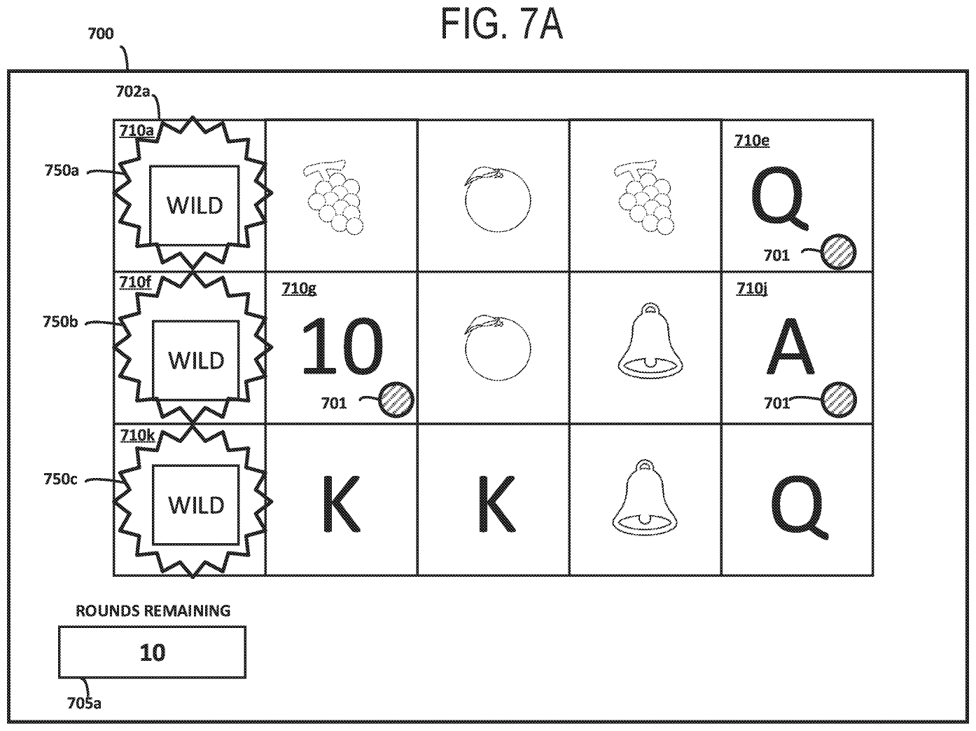

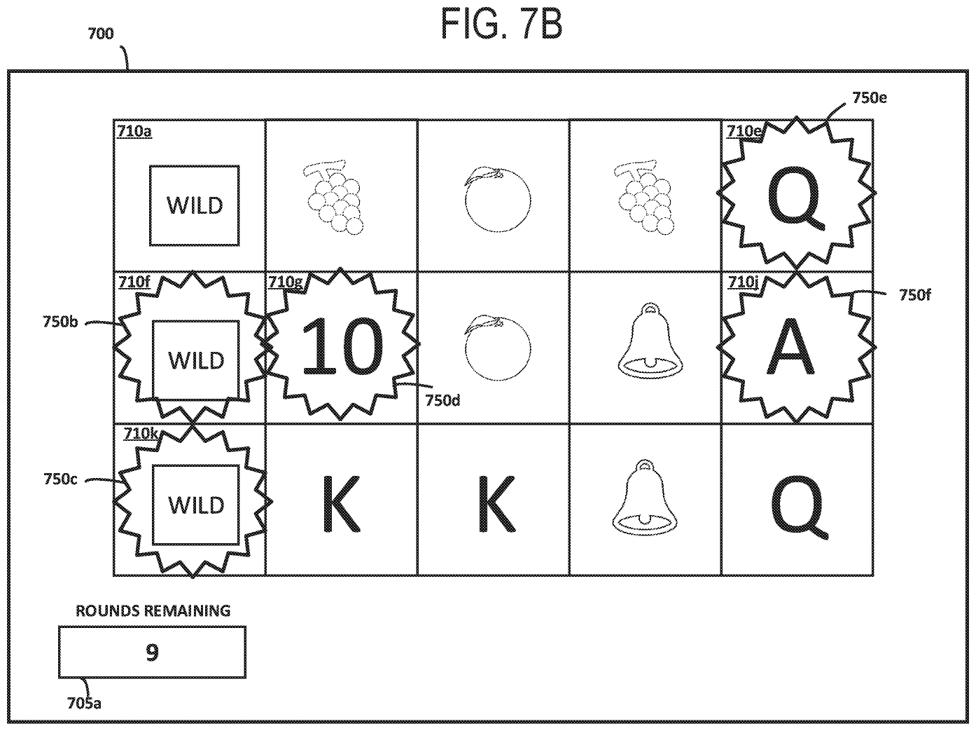

In some implementations where the collection symbols are generated in a bonus game, the gaming system may visibly mark a symbol display area where a collection symbol was generated. The visible marks for symbol display areas can be in lieu of storage areas (e.g., 603a-603e of FIG. 6B) or can work in conjunction with such storage areas. FIGS. 7A and 7B illustrate screen shots of one implementation of a gaming system that provides a bonus game for generating collection symbols and marking symbol display areas where a collection symbol was generated. FIGS. 7A and 7B illustrate a certain implementation of a game screen 700 that the gaming system 100 may display on a display device of the gaming system. In some implementations, game screen 700 may be displayed on the first display 120 or a second display 130 of gaming system 100 illustrated in FIG. 1. However, any other suitable display may be used. For the sake of brevity, to the extent that FIGS. 7A and 7B share features similar to the features already discussed above in connection with FIGS. 3A, 3B, 4A, 4B, 5A-5E, and 6A-6C, such similar features will not be described again.

In some implementations, as illustrated in FIG. 7A, the gaming system may visibly mark each symbol display area where a collection symbol was generated. In some implementations, the gaming system may visibly mark a symbol display area by highlighting the symbol display area with colored boxes, halos, or other suitable highlighting around a symbol display area to illustrate that a collection symbol was generated therein. For example, the gaming system created halos 750a, 750b, and 750c for symbol display areas 710a, 710f, and 710k as shown in FIG. 7A because the gaming system previously generated collection symbols in these symbol display areas. As another example, the gaming system generated collection symbols 701 in symbol display areas 710e, 710g, and 710j as illustrated in FIG. 7A. As illustrated in FIG. 7B, the gaming system generated halos 750d, 750e, and 750f due to the generated collection symbols 701 from FIG. 7A.

In some implementations where boxes, halos, or other suitable highlighting are used to mark a symbol display area, the gaming system may continue to display such markings for a predetermined quantity of rounds of the bonus game (e.g., five rounds of the bonus game, or some other suitable quantity of rounds of the bonus game). In some implementations where boxes, halos, or other suitable highlighting are used to mark a symbol display area, the gaming system may continue to display such markings on a particular reel during the bonus game (e.g., multiple rounds of the bonus game) until a predetermined event occurs. In some implementations, the predetermined event can be when a threshold predetermined quantity of markings are removed from a particular reel. For example, in some implementations, the gaming system may remove one halo on reel 702a in FIG. 7A after a round of the bonus game. FIG. 7B illustrates that the gaming system removed the halo 750a from symbol display area 710a. In some implementations, the threshold removed predetermined quantity of markings is three or some other suitable quantity. For example, after the gaming system removes halo 750b and 750c from reel 702a, the gaming system may convert the Wild symbols in on reels 702a back into non-Wild symbols. In some implementations, the threshold removed predetermined quantity of markings is based on the quantity of symbol display areas of a particular reel that include a marking or a halo. The predetermined event can be other suitable predetermined events. For example, the predetermined event can be after the gaming system executes a threshold quantity of rounds of the bonus game. In some implementations, the gaming system may decrease/adjust a counter (e.g., information area 705a) for remaining rounds of the bonus game as the gaming system removes marked symbol display areas.

In some implementations, when a predetermined quantity of markings are displayed on a particular reel, the gaming system may convert one or more of symbols on such a reel with the predetermined quantity of markings (e.g., three or some other suitable quantity) into Wild symbols. As illustrated in FIG. 7A, the gaming system converted symbols in symbol display area 710a, 710f, and 710k into the Wild symbols shown in these symbol display areas. In some implementations, the gaming system may convert one symbol on the reel into a Wild symbol for each marked symbol display area. As illustrated in FIG. 7B, the gaming system did not convert the symbols in symbol display areas 710e, 710g, and 710j into Wild symbols because the symbol display areas did not include a predetermined quantity of markings. It should be appreciated that converting symbols to Wild symbols based on marked symbol display areas can be used alone or in conjunction with other features discussed herein.

In some implementations, where the gaming system converts symbols on a plurality of reels into Wild symbols (e.g., as illustrated in FIGS. 7A and 7B), the gaming system may provide additional awards or additional game features that enable a player to win even more awards. For example, in some implementations where the gaming system converted symbols on at least three reels into Wild symbols, the gaming system may provide the player with a jackpot award (e.g., a minor jackpot award). In some implementations, if the gaming system converted symbols on more reels (e.g., four reels) into Wild symbols, the gaming system may provide the player with a jackpot award (e.g., a major jackpot award) that is larger in value than the jackpot award for converting three reels into Wild symbols. Likewise, if the gaming system converted symbols on even more reels (e.g., five reels) into Wild symbols, the gaming system may provide the player with a still larger jackpot award (e.g., a grand jackpot award) that is larger in value than the jackpot award for converting four reels into Wild symbols. In some implementations, instead of or in addition to the different jackpot awards, the gaming system may award additional rounds of a bonus game (e.g., increase information area 705a by the quantity of rounds won for the reels with Wild symbols). In some implementations, the gaming system may award another game feature for obtaining a predetermined quantity of reels with Wild symbols. For example, another game feature can be awarding one or more different wheels to spin. The wheels may be divided into a number of sections, where the sections are associated with one or more awards (e.g., credit values). The gaming system may spin the wheel and randomly determine one or more of the wheels sections to indicate. The gaming system may provide the award to the player based upon the indicated wheel section. In some implementations, the gaming system may provide a first wheel with a first set of awards where the gaming system converted symbols on at least three reels into Wild symbols. In some implementations, if the gaming system converted symbols on more reels (e.g., four reels) into Wild symbols, the gaming system may provide the player with a second wheel with a second set of awards for converting four or more reels into Wild symbols (e.g., the second set of awards can have a higher value than the first set of awards associated with the first wheel). Likewise, if the gaming system converted symbols on even more reels (e.g., five reels) into Wild symbols, the gaming system may provide the player with a third wheel with a third set of awards for converting five or more reels into Wild symbols (e.g., the third set of awards can have a higher value than the second set of awards associated with the second wheel). It should be appreciated that foregoing quantities are for example only and other suitable quantities can be used.

Based on the forgoing description, it should be appreciated that a gaming system and method with improvements to game outcomes by providing a bonus game for generating and storing collection symbols in one or more collection symbol storage areas creates new and very exciting ways for a player to obtain improved winnings with a potential to earn greater awards. Such a potential to earn greater awards creates a greatly improved sense of anticipation for players.

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a processor;
a display device;
an input device;
a value acceptor;
a value dispenser;
a memory device that stores a plurality of instructions which, when executed by the processor, cause the processor to:
establish a credit balance based on a monetary value received by the value acceptor;
decrease the credit balance by a wager amount received via the input device;
randomly generate a plurality of symbols from a plurality of symbol sets;
randomly generate one or more collection symbols from a second plurality of symbol sets;
display, on the display device, the plurality of symbols in a plurality of symbol display areas;
display, on the display device, the one or more collection symbols in one or more of the plurality of symbol display areas;
evaluate the plurality of symbols for winning symbol combinations;
evaluate the symbol display areas for the one or more collection symbols;
store the collection symbols in one of a plurality of different collection symbol storage areas;
display, on the display device, an award based on any winning symbol combinations and based on the quantity of collection symbols in the plurality of different collection symbol storage areas;
increase the credit balance by the award; and
issue value from the value dispenser based on the credit balance upon receipt of a cash out signal via the input device.

2. The gaming system of claim 1, wherein the plurality of instructions further cause the processor, when displaying, on the display device, the or more collection symbols in one or more of the plurality of symbol display areas, to:
overlay the one or more collection symbols on corresponding ones of the symbols provided in the one or more of the plurality of symbol display areas.

3. The gaming system of claim 1, wherein the plurality of instructions further cause the processor to award one or more free games when a quantity of the one or more collection symbols in one of the plurality of different collection symbol storage areas exceeds a threshold.

4. The gaming system of claim 1, wherein the plurality of instructions further cause the processor to increase an award associated with a winning symbol combinations when a quantity of the one or more collection symbols in one of the plurality of different collection symbol storage areas exceeds a threshold.

5. The gaming system of claim 1, wherein the plurality of instructions further cause the processor to increase a quantity of the one or more collection symbols in one of the plurality of different collection symbol storage areas during a second free game when the quantity of the one or more collection symbols exceeds a threshold during a first free game that occurs prior to the second free game.

6. The gaming system of claim 1, wherein the plurality of instructions further cause the processor to:
determine quantities of the collection symbols stored in the plurality of different collection symbol storage areas; and
convert one or more of the plurality of symbols to a wild symbol when a quantity of collection symbols stored in one of the plurality of different symbol storage areas exceeds a threshold.

7. The gaming system of claim 1, wherein the plurality of symbol display areas are associated with a plurality of reels; and
wherein the plurality of instructions further cause the processor to:
store the collection symbols in a plurality of collection symbol storage areas associated with, respectively, the plurality of reels.

8. The gaming system of claim 7, wherein the plurality of instructions further cause the processor, when storing the collection symbols in the plurality of collection symbol storage areas associated with the plurality of reels, to:
determine one of the reels corresponding to each of the collection symbols, and
store each of the collection symbols in the one of the symbol storage areas associated with a corresponding one of the plurality of reels.

9. The gaming system of claim 7, wherein the plurality of instructions further cause the processor, when storing the collection symbols in the plurality of collection symbol storage areas associated with the plurality of reels, to:
determine a quantity of the collection symbols stored in one of the collection symbol storage areas; and
convert one or more of the plurality of symbols, associated with one of the reels corresponding to the one of the collection symbol storage areas, to a wild symbol when the quantity of the collection symbols stored in the one of the collection symbol storage areas exceeds a threshold.

10. The gaming system of claim 9, wherein the plurality of instructions further cause the processor to:
provide a second award, which is larger than other available awards, when a quantity of reels having symbols converted to the wild symbol equals or exceeds a threshold number.

11. The gaming system of claim 10, wherein the plurality of instructions further cause the processor, when providing the second award, to:
provide a third award when the quantity of reels having symbols converted to the wild symbol equals or exceeds a first threshold number, and
provide a fourth award that is more than the third award when the quantity of reels having symbols converted to the wild symbol equals or exceeds a second threshold number that is greater than the first threshold number.

12. The gaming system of claim 1, wherein the plurality of instructions further cause the processor to:
determine when the plurality of symbols include a trigger symbol or a trigger combination; and
display the one or more collection symbols based on determining that the plurality of symbols include the trigger symbol or the trigger combination.

13. The gaming system of claim 1, wherein the plurality of instructions further cause the processor to display the one or more collection symbols based on receiving an input via a bonus controller.

14. The gaming system of claim 1, wherein the plurality of instructions further cause the processor to display the one or more collection symbols as one or more coins.

15. The gaming system of claim 1, wherein the plurality of instructions further cause the processor to display the one or more collection symbols as one or more horizontal bars.

16. A method of operating a gaming system, the method comprising:
receiving, by a monetary value acceptor, a monetary value;
establishing, by a processor of the gaming system, a credit balance based at least in part on the received monetary value;
accepting, from an input device in a housing of the gaming system, a wager amount;
decreasing, by the processor, the credit balance by the wager amount;
randomly generating a plurality of symbols from a plurality of symbol sets;
displaying, on the display device, the plurality of symbols in a plurality of symbol display areas;
randomly generating one or more collection symbols from a second plurality of symbol sets;
displaying, on a display device, the one or more collection symbols in one or more of the plurality of symbol display areas;
evaluating the plurality of symbols for winning symbol combinations;
evaluating the symbol display areas for the one or more collection symbols;
storing the collection symbols in one of a plurality of different a collection symbol storage areas;
displaying, on the display device, an award based on any winning symbol combinations and based on the quantity of collection symbols in the plurality of different collection symbol storage areas;
increasing the credit balance by the award; and
issuing a value from a value dispenser based on the credit balance upon receipt of a cash out signal via the input device.

17. The method of operating the gaming system of claim 16, wherein the plurality of symbol display areas are associated with a plurality of reels; and
wherein the method further comprises:
storing the collection symbols in the plurality of different collection symbol storage areas associated with, respectively, the plurality of reels.

18. The method of claim 17, wherein further comprising:
determining one of the reels corresponding to each of the collection symbols, and
storing each of the collection symbol to the one of the plurality of different symbol storage areas associated with a corresponding one of the plurality of reels.

19. The method of claim 17, wherein further comprising:
determining a quantity of the collection symbols stored in one of the plurality of different collection symbol storage areas; and
converting one or more of the plurality of symbols, associated with one of the reels corresponding to the one of the plurality of different collection symbol storage areas, to a wild symbol when the quantity of the collection symbols stored in the one of the plurality of different collection symbol storage areas exceeds a threshold.

20. A non-transitory computer-readable storage medium having machine instructions stored therein, the instructions being executable by a processor to cause the processor to:
establish a credit balance based at least in part on a monetary value received by a value acceptor of a gaming device;
place a wager following receipt of a wager input via an input device;
decrease the credit balance by the wager;
randomly generate a plurality of symbols from a plurality of symbol sets;
randomly generate one or more collection symbols from a second plurality of symbol sets;
display, on a display device, the plurality of symbols in a plurality of symbol display areas;
display, on the display device, the one or more collection symbols in one or more of the plurality of symbol display areas;
evaluate the plurality of symbols for winning symbol combinations;
evaluate the symbol display areas for the one or more collection symbols;
store the collection symbols in a collection symbol storage area;
display, on the display device, an award based on any winning symbol combinations and based on the quantity of collection symbols in the collection symbol storage area;
increase the credit balance by the award; and
issue value from a value dispenser based on the credit balance upon receipt of a cash out signal via the input device.
